(19) United States
(12) Patent Application Publication
(10) Pub. No.: US 2008/0270091 A1
(43) Pub. Date: Oct. 30, 2008

(54) SCALING METHOD FOR FAST MONTE CARLO SIMULATION OF DIFFUSE REFLECTANCE SPECTRA FROM MULTI-LAYERED TURBID MEDIA AND METHODS AND SYSTEMS FOR USING SAME TO DETERMINE OPTICAL PROPERTIES OF MULTI-LAYERED TURBID MEDIUM FROM MEASURED DIFFUSE REFLECTANCE

(76) Inventors: Nirmala Ramanujam, Chapel Hill, NC (US); Quan Liu, Durham, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/036,717

(22) Filed: Feb. 25, 2008

Related U.S. Application Data
(60) Provisional application No. 60/903,177, filed on Feb. 23, 2007.

(51) Int. Cl. G06G 7/48

(52) U.S. Cl. 703/6

(57) ABSTRACT

The presently disclosed subject matter relates to multilayered scaling methods that allow for implementation of fast Monte Carlo simulations of diffuse reflectance from multilayered turbid media. The disclosed methods employ photon trajectory information provided by only a single baseline simulation, from which the diffuse reflectance can be computed for a wide range of optical properties in a multilayered turbid medium. A convolution scheme is also incorporated to calculate diffuse reflectance for specific fiber-optic probe geometries. Also provided are systems for fast Monte Carlo simulation of diffuse reflectance of a multilayered turbid medium to rapidly determine diffuse reflectance for the multilayered turbid medium with known optical properties and for using the scaled diffuse reflectance to determine optical properties of a turbid medium having unknown optical properties.

### RELATED APPLICATIONS

The presently disclosed subject matter claims the benefit of U.S. Provisional Patent Application Ser. No. 60/903,177, filed Feb. 23, 2007; the disclosure of which is incorporated herein by reference in its entirety.

### GOVERNMENT INTEREST

This presently disclosed subject matter was made with U.S. Government support under Grant Nos. 1R21 CA108490 and 1R01CA100559-01A awarded by National Institutes of Health. Thus, the U.S. Government has certain rights in the presently disclosed subject matter.

### TECHNICAL FIELD

The presently disclosed subject matter relates generally to multi-layered scaling methods that allow for implementation of fast Monte Carlo simulations of diffuse reflectance from multi-layered turbid media. More particularly, the presently disclosed subject matter relates to methods that employ photon trajectory information provided by only a single baseline simulation to compute diffuse reflectance for a wide range of optical properties in multi-layered turbid media.

### BACKGROUND

Ultraviolet-visible (UV-VIS) diffuse reflectance spectroscopy has been explored to detect precancers and cancers in a variety of epithelial tissues (Palmer et al., 2006; Verkruysse et al., 2005; Merritt et al., 2003; Doornbos et al., 1999; Zonios et al., 1999). This nondestructive technique has several attributes. First, diffuse reflectance spectra contain a wealth of biochemical and structural information related to disease progression (Pavlova et al., 2003; Collier et al., 2003; Drezek et al., 2001; Ramanujam et al., 2000). Moreover, broadband light sources, sensitive detectors, and compact fiber-optic probes enable rapid and remote measurements of diffuse reflectance from tissue surfaces and endoscopically accessible organ sites.

In such applications, an accurate model of light transport is essential to quantitatively extract optical properties from measured diffuse reflectance spectra. Diffusion theory and the modified versions of this analytical model have been used to extract optical properties and relevant biochemical and structural information from diffuse reflectance measurements previously (van Veen et al., 2005; Merritt et al., 2003; Doornbos et al., 1999; Zonios et al., 1999). However, diffusion theory is not valid to describe light propagation at small source-detector separations (Farrell et al., 1992) and for the case where absorption and scattering are comparable, such as diffuse reflectance measurements in the UV-VIS spectral region. In these situations, the Monte Carlo method provides a flexible tool to model light transport in turbid media.

In addition, the capability of Monte Carlo modeling to simulate complex tissue structures and fiber-optic geometries has made it very attractive as a model of light transport. However, the main drawback of the Monte Carlo method is the requirement for intensive computational resources to achieve results with desirable variance, which makes it extremely time consuming compared with analytical models such as diffusion theory.

A considerable amount of effort has been made to improve the efficiency of the Monte Carlo method for modeling light transport in turbid media. Several reports have demonstrated the use of improved Monte Carlo methods, or simply Monte Carlo databases created beforehand with conventional Monte Carlo modeling, to estimate the optical properties of the tissue from given diffuse reflectance data in the spatial (Bevilacqua et al., 1999; Kienle et al., 1996), time (Kienle & Patterson, 1996), or frequency (Merritt et al., 2003; Hayakawa et al., 2001) domains, and/or as a function of wavelength (Verkruysse et al., 2005). The methods proposed to increase the efficiency of Monte Carlo modeling can be broadly separated into two groups: methods that accelerate a single Monte Carlo simulation (Liu & Ramanujam, 2006; X-5 Monte Carlo Team, 2003; Tinet et al., 1996) and methods that take advantage of information generated by a small set of Monte Carlo baseline simulations for a wide range of optical properties (U.S. Patent Application Publication Nos. 2007/0232932 and 2006/0247532; Palmer & Ramanujam, 2006; Swartling et al., 2003; Hayakawa et al., 2001; Sassaroli et al., 1998; Kienle & Patterson, 1996; Graaff et al., 1993; Battistelli et al., 1985).

The first set of methods (Liu & Ramanujam, 2006; X-5 Monte Carlo Team, 2003; Tinet et al., 1996) can accelerate a single Monte Carlo simulation to achieve desirable variance in simulated results. For example, the geometry-splitting technique can increase the fraction of useful photons for a specific fiber-optic probe geometry, thus reducing the total number of incident photons needed to minimize the variance of simulated diffuse reflectance (Liu & Ramanujam, 2006; X-5 Monte Carlo Team, 2003). Tinet et al. 1996 proposed a semi-analytical Monte Carlo method for time-resolved light propagation. Each random-walk step of a photon contributes deterministically to a detector area, thus dramatically improving the variance of detected signals especially when the goal is to simulate rarely occurring events.

The second set of methods (U.S. Patent Application Publication Nos. 2007/0232932 and 2006/0247532; Palmer & Ramanujam, 2006; Swartling et al., 2003; Hayakawa et al., 2001; Sassaroli et al., 1998; Kienle & Patterson, 1996; Graaff et al., 1993; Battistelli et al., 1985) takes the information collected from a single baseline simulation or a small set of baseline simulations and uses them to generate diffuse reflectance or transmittance for a wide range of optical properties. For example, the reciprocity theorem has been employed to reduce the number of Monte Carlo simulations for fluorescence propagation in layered media (Swartling et al., 2003). The perturbation Monte Carlo method records the trajectory information for each individual detected photon in a baseline simulation and adjusts the exit weight of the photons for small changes of optical properties in layered media (Hayakawa et al., 2001) or for the perturbation of small heterogeneities present in a homogeneous medium (Sassaroli et al., 1998) according to proper differential operators. However, the accuracy of the perturbation method is sensitive to changes in the scattering coefficient (Hayakawa et al., 2001; Sassaroli et al., 1998), thus limiting the applicable range of the data generated from a single baseline simulation.

The scaling method is another powerful approach that requires photon trajectory information from a baseline simulation. Battistelli et al. 1985 proposed two scaling relations for calculation of transmittance in a Monte Carlo simulation. Graaff et al. 1993 took advantage of the fact that the step sizes of random walk in a Monte Carlo simulation are linearly related to the inverse of the transport coefficient (sum of absorption and scattering coefficients) and developed two very useful scaling relations, one of which relates the exit distance of a photon to the transport coefficient of a homogeneous medium and the other relates the exit weight to the albedo. Kienle & Patterson, 1996 created a Monte Carlo database for the estimation of optical properties of a homogeneous medium from given time-resolved reflectance by using the relations proposed by Graaff et al. 1993 to account for the change in the scattering coefficient and using Beer's law to account for the absorption coefficient. Palmer & Ramanujam, 2006 developed a scaling Monte Carlo method to extract optical properties from diffuse reflectance spectra of a homogeneous medium in the UV-VIS spectral region. Again, the scaling approach by Graaff et al. 1993 was used such that only a single Monte Carlo simulation was needed for a particular fiber-optic probe geometry.

Unfortunately, none of these studies addresses the need for a method that can implement fast Monte Carlo simulations of diffuse reflectance from multilayered turbid media.

Recently, the instant co-inventors reported an extension of the capabilities of the scalable Monte Carlo model developed by Palmer & Ramanujam, 2006 to sequentially estimate the optical properties of a two-layered squamous epithelial tissue model (Liu & Ramanujam, 2006). In the second step of this sequential estimation method, a database that contains diffuse reflectance data simulated from the two-layered tissue model for a wide range of optical properties was required prior to the inversion process to estimate the optical properties of the bottom layer (assuming that the optical properties of the top layer have been obtained in the first step). To reduce the number of required independent simulations, a strategy called white Monte Carlo simulation was used (Swartling et al., 2003; Kienle & Patterson, 1996). Several Monte Carlo simulations were run with zero absorption and various scattering coefficients, and the path lengths of detected photons were recorded. The effect of absorption was incorporated post-simulation according to Beer's law. Although this strategy reduced the total number of simulations by roughly three orders of magnitude, it still required a significant number of independent simulations (a total of 819 simulations, each with 106 incident photons), which took about four weeks to complete on a cluster of Sun UNIX computers equipped with the CONDOR distributed computing software (The Condor Team, 1997-2006).

What are needed, then, are new methods for estimating optical properties of multilayered turbid media. To address this need, at least in part, the subject matter described herein includes a multilayered scaling model that allows for implementation of fast Monte Carlo simulations of diffuse reflectance from multilayered turbid media and methods and systems for using the model to determine optical properties of turbid media.

### SUMMARY

This Summary lists several embodiments of the presently disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

The presently disclosed subject matter provides methods for fast Monte Carlo simulation of diffuse reflectance of a multi-layered turbid medium to determine scaled diffuse reflectance for the multi-layered turbid medium and for using the scaled diffuse reflectance to determine optical properties of a multi-layered turbid medium with unknown optical properties. In some embodiments, the methods comprise performing a baseline Monte Carlo simulation of diffuse reflectance of a homogeneous turbid medium to determine a baseline set of simulated photon trajectories and exit weights for the homogeneous turbid medium; scaling, based on relative optical properties of each layer in an n-layered turbid medium with selected optical properties to the optical properties of the homogenous turbid medium, the simulated photon trajectories and weights determined for the homogeneous turbid medium to determine a set of calculated photon trajectories and exit weights for the n-layered turbid medium and, from the set of calculated photon trajectories and exit weights, an impulse response representing photon exit weights and exit positions for the n-layered turbid medium; convolving the impulse response with a beam profile for a source-detector geometry to determine a scaled diffuse reflectance for the n-layered turbid medium that would be detected by the source-detector geometry; and using the scaled diffuse reflectance for the n-layered turbid medium with selected optical properties as a predicted diffuse reflectance input to an inverse model to determine optical properties of an n-layered turbid medium with unknown optical properties based on measured diffuse reflectance of the n-layered turbid medium with unknown optical properties.

The presently disclosed subject matter also provides systems for fast Monte Carlo simulation of diffuse reflectance of a multilayered turbid medium to determine a scale diffuse reflectance for the multilayered turbid medium and for using the scaled diffuse reflectance to determine optical properties of a turbid medium having unknown optical properties. In some embodiments, the systems comprise a baseline Monte Carlo simulation module for performing a baseline Monte Carlo simulation of diffuse reflectance of a homogeneous turbid medium to determine a baseline set of simulated photon trajectories and exit weights for the homogeneous turbid medium; a scaling module for scaling, based on relative optical properties in each layer in an n-layered turbid medium with selected optical properties to the optical properties of the turbid medium, the simulated photon trajectories and weights determined for the homogeneous turbid medium to determine a set of calculated photon trajectories and exit weights for the n-layered turbid medium, and, from the set of calculated photon trajectories and exit weights, an impulse response representing photon exit weights and exit positions for the n-layered turbid medium, wherein the scaling module is adapted to scale the photon trajectories for each layer in the n-layered turbid medium plural times to create a database of scaled photon trajectories and exit weights for the n-layered turbid medium; and an inverse model for receiving as inputs the scaled simulated diffuse reflectance value stored in the database and measured diffuse reflectance from a multilayered turbid medium with unknown optical properties and for outputting optical properties of the multilayered turbid medium. In some embodiments, the baseline Monte Carlo simulation module is adapted to perform a single Monte Carlo simulation with a predetermined set of optical properties.

In some embodiments of the presently disclosed subject matter, performing a baseline Monte Carlo simulation includes performing a single Monte Carlo simulation with a predetermined known set of optical properties. In some embodiments, the predetermined known set of optical properties includes an absorption coefficient, a scattering coefficient, and an anisotropy factor. In some embodiments, the predetermined known set of optical properties includes a numerical aperture of a simulated illumination fiber and a simulated collection fiber. In some embodiments, performing a baseline Monte Carlo simulation includes dividing the homogeneous turbid medium into depth intervals of constant and/or increasing thickness and measuring photon exit weights, number of collisions, and spatial offsets from incident photon positions in each depth interval.

In some embodiments, scaling the simulated photon trajectories based on the relative optical properties includes calculating thickness for a pseudo layer for each layer in the n-layered turbid medium with selected optical properties, the pseudo layer thickness for each pseudo layer being based on the optical properties of that layer relative to the optical properties of the homogeneous turbid medium and the pseudo layer having the optical properties of the homogeneous turbid medium, and determining a photon trajectory for each photon in each layer in the n-layered medium with selected optical properties based on the photon trajectory in the corresponding pseudo layer. In some embodiments, scaling the simulated photon trajectories based on the relative optical properties includes determining a number of photon trajectories and a horizontal offset that each photon experiences in each pseudo layer before exiting the n-layered turbid medium with selected optical properties based on trajectory information from the baseline Monte Carlo simulation. In some embodiments, scaling the photon trajectories based on the relative optical properties includes scaling a horizontal offset for each real layer in the n-layered turbid medium with selected optical properties according to a transport coefficient of each real layer and determining a vector sum of the horizontal offsets determined for all layers in the n-layered turbid medium with selected optical properties to determine a scaled exit distance for each photon exiting the n-layered turbid medium with selected optical properties. In some embodiments, scaling the photon weights includes calculating a photon weight change in each pseudo layer according to an albedo of each real layer in the n-layered turbid medium with selected optical properties and a number of collisions in each pseudo layer and computing a product of all of the weight change terms to determine a scaled exit weight for each photon exiting the n-layered turbid medium with selected optical properties.

In some embodiments, using the scaled diffuse reflectance as a predicted reflectance input to determine optical properties of the n-layered turbid medium with unknown optical properties includes measuring diffuse reflectance of the turbid medium with unknown optical properties using an optical probe; applying the inverse model using the scaled diffuse reflectance and the measured diffuse reflectance as inputs and producing an indicator of the difference between the scaled diffuse and measured diffuse reflectances as output; iteratively repeating the inverse model by altering the scaled diffuse reflectance input until the indicator of the difference reaches a minimum value; and outputting, as optical properties of the turbid medium having unknown optical properties, optical property values corresponding to the scaled diffuse reflectance that corresponded to the minimum value of the indicator. In some embodiments, the indicator of the difference comprises a sum of squares of errors between the scaled and measured diffuse reflectances for different wavelengths. In some embodiments, outputting the optical values includes outputting an absorption coefficient, a scattering coefficient, and an anisotropy factor.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

FIGS. 1A and 1B are graphical representations of the principle of the scaling method as applied in a homogeneous medium (FIG. 1A) and a two-layered medium (FIG. 1B). In both FIGS. 1A and 1B, the horizontal bold line is the air-medium interface, the solid lines with arrows represent the trajectory of a photon in a baseline medium, and the dashed lines with arrows represent the scaled trajectory of the same photon in a new medium with a different set of optical properties. The incident locations of the two trajectories were supposed to overlap, but they were purposefully shifted away from each other in the above figures for better differentiation. The baseline transport coefficient (μₜ) is μₜ₀ in both FIGS. 1A and 1B. For homogeneous scaling in FIG. 1A, it is assumed that the new μₜ is half of μₜ₀. For the layered scaling in FIG. 1B, it is assumed that the μₜ of the top layer is twice μₜ₀ and the μₜ of the bottom layer is half of μₜ₀. In FIG. 1B, the horizontal dashed line in the middle stands for the layer interface in the two-layered medium, while the horizontal solid line in the bottom represents the corresponding location of the layer interface in the baseline medium as if the baseline medium were two-layered with a pseudolayer interface.

FIGS. 2A and 2B are schematic representations of two-layered and three-layered epithelial tissue models for testing the accuracy of the multilayered scaling method. The optical properties of the top layer are shown in FIG. 3A, the optical properties of the bottom layer are shown in FIG. 3B, and the optical properties of the middle layer are shown in FIG. 3C. It should be noted that the thicknesses of the top layer and the middle layer in FIG. 2B add up to the thickness of the top layer in FIG. 2A.

FIGS. 3A-3C are graphs showing absorption and reduced scattering coefficients of the top layer (FIG. 3A), bottom layer (FIG. 3B), and middle layer (FIG. 3C) at a range of wavelengths from 360 to 660 nm in a two-layered and a three-layered theoretical epithelial tissue model. Open circle: Absorption; [symbol] : Scattering.

FIG. 4 is a graph depicting diffuse reflectance as a function of the source-detector separation at a single wavelength (500 nm) for the original two-layered epithelial tissue model. The star symbols in the inset are the percent deviations of the scaled reflectance value relative to the mean of six independently simulated reflectance values as calculated in Equation (1) for each separation. The open circles in the inset represent zero percent deviation. The error bar indicates 95% confidence interval (CI) of the percent deviation of simulated reflectance values relative to its expected value, which was calculated according to Equation (2). Open circle: Simulated; [symbol] : Scaled.

FIGS. 5A and 5B are a series of graphs depicting simulated and scaled diffuse reflectance (FIG. 5A) and percent deviation of scaled reflectance relative to simulated reflectance (FIG. 5B) calculated according to Equation (1) as a function of wavelength at four separations (0, 200, 800, and 1500 μm in the order from the top to the bottom) for the original two-layered epithelial tissue model. The 95% CI of the percent deviation of simulated reflectance relative to its expected value was calculated according to Equation (2) and illustrated by the error bars in FIG. 5B. The open circles in FIG. 5B are the mean of the percent deviation of simulated reflectance relative to its expected value, which is always zero because the expected value was estimated by the mean of simulated reflectance. Open circle: Simulated; [symbol] : Scaled.

FIG. 6 is a graphical representation of simulated reflectance as a function of separation from a modified two-layered epithelial tissue model at a wavelength of 500 nm, where the refractive index of the medium above the tissue model was varied from 1.0 to 1.338 to 1.462 and to 1.6 and other parameters were kept identical to those in the original two-layered epithelial tissue model. The scaled reflectance as a function of separation is also shown, for which the refractive index of the medium above the tissue model was 1.462 in the baseline simulation. The inset graph shows the percent deviation of scaled reflectance relative to simulated reflectance for different refractive indices as a function of separation. The dashed line in the inset represents zero percent deviation. Circles: n=1 (Simulated); Squares: n=1.338 (Simulated); Triangles: n=1.462 (Simulated); Diamonds: n=1.6 (Simulated); [symbol] : n=1.462 (Scaled).

FIG. 7 is a graphical representation of simulated reflectance as a function of separation at a wavelength of 500 nm for a modified two-layered epithelial tissue model, in which the phase function was calculated from Mie theory (Bohren & Huffman, 1983) and other parameters including absorption and reduced scattering coefficients were kept identical to the original two-layered epithelial tissue model. The reflectance simulated for the original two-layered epithelial tissue model and the scaled reflectance, in which the HG phase function was used, are also shown for comparison. The inset graph shows the percent deviation of scaled reflectance relative to the two sets of simulated reflectance. The dashed line in the inset represents zero deviation. Circles-Mie, Simulated; Triangles-HG, Simulated; [symbol] -HG, Scaled.

FIGS. 8A and 8B are schematic representations of a flat-tip fiber-optic probe geometry for diffuse reflectance measurement from a semi-infinite two-layered epithelial tissue phantom (FIG. 8A) and of the scaled version of the phantom and the probe geometry (FIG. 8B). In FIG. 8A, μₜ₁ and μₜ₂ are the transport coefficients of the top and bottom layers, α₁ and α₂ are the albedos of the two layers, the thickness of the top layer is d₁, the diameter of both source and detector fibers is D, and the source-detector separation is ρ. In FIG. 8B, the transport coefficients of the top and bottom layers are μₜ₁/N and μₜ₂/N, the albedos of the two layers are still α₁ and α₂, the thickness of the top layer becomes d₁×N, the diameter of both source and detector fibers is D×N, and the source-detector separation is ρ×N. Two representative photon trajectories were drawn in both FIGS. 8A and 8B to illustrate the scaling operation.

FIGS. 9A and 9B are flow charts illustrating a sequential estimation method where optical properties of a turbid medium can be determined from measured diffuse reflectance and where the scaling methods described herein can be used to reduce the number of Monte Carlo simulations required.

FIG. 10 is a block diagram of a system for estimating optical properties of a turbid medium from measured diffuse reflectance using the scaling method described herein in the forward Monte Carlo model.

### DETAILED DESCRIPTION

### I. Principle of the Multilayered Scaling Method

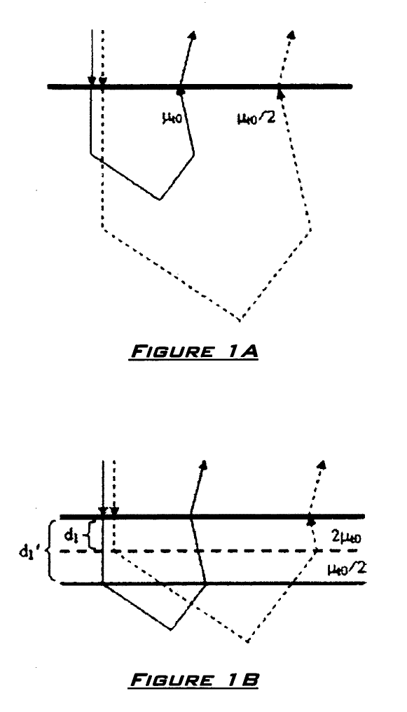

In principle, the multilayered scaling method is similar to the scaling method for a homogeneous medium as described by Graaff et al., 1993. For the purpose of comparison, FIG. 1A illustrates the scaling method as applied to a homogeneous medium. The solid lines with arrows represent the trajectory of a photon in a baseline medium, and the dashed lines with arrows are the scaled trajectory for a new medium where the transport coefficient (μₜ) is half of the baseline value. When μₜ decreases by one half, the mean free path of the photon, which is the reciprocal of μₜ, increases by a factor of 2. Subsequently, the exit location of the photon after scaling is displaced from the incident location by a factor of 2 relative to the original exit location if every step of the random walk is sampled with exactly the same random numbers as in the baseline simulation.

The above procedure can be mathematically formulated as follows. Some key notations are defined first. The transport coefficient denoted by μₜ is the sum of the absorption (μₐ) and scattering (μₛ) coefficients. The albedo is denoted by α, and α=μₛ/μₜ. Assume the transport coefficient in the baseline medium is μₜ₀ and the albedo is α₀. The number of collisions that a photon experiences before exit is N, and the photon escapes from the top surface of the medium at a distance of r₀ from the incident location (which will be called the exit distance from now on). Then the photon weight upon exit is ω₀=α₀^{N}. For a new set of optical properties where the transport coefficient is μₜ and the albedo is α, the scaled exit distance is r=r₀×μₜ₀/μₜ, and the exit weight is ω=α^{N}=ω₀×(α/α₀)^{N}.

FIG. 1B illustrates the scaling method as applied to a two-layered medium. Again, the solid lines with arrows are the trajectory of a photon in a baseline homogeneous medium with a transport coefficient of μₜ₀, and the dashed lines are the scaled trajectories in a two-layered medium. In this example, the top layer μₜ is twice μₜ₀, the bottom layer μₜ is half of μₜ₀, and the top-layer thickness is d₁ (the dashed horizontal line indicates the layer interface between the top and the bottom layers in the two-layered medium). The first step in the scaling process is to find the corresponding location of the layer interface in the baseline medium. Because the top layer μₜ is twice μₜ₀, the mean free path in the top layer is half of that in the baseline medium. Therefore, the top-layer thickness should be doubled to obtain the corresponding location of the layer interface in the baseline medium: i.e., d′₁=2d₁. Thus, the baseline medium can be viewed as a pseudo-two-layered medium with a pseudolayer interface at depth d′₁=2d₁. The random-walk steps of the photon in the baseline medium can then be separated into two groups according to their location relative to the pseudolayer interface in the baseline medium. Any steps that are within the pseudo top layer (depth smaller than d′₁) are scaled according to the optical properties of the top layer in the two-layered medium. Similarly, the steps that are within the pseudo bottom layer (depth larger than d′₁) in the baseline medium are scaled according to the optical properties of the bottom layer in the two-layered medium. In this specific situation, all photon steps in the top layer are cut short by half, and all photon steps in the bottom layer are stretched by a factor of 2. The exit distance of the photon is the vector sum of the scaled steps in the horizontal dimension (in the plane parallel to the medium top surface where diffuse reflectance is measured) as shown in FIG. 1B.

Similar to the previous procedure for homogeneous scaling, the above procedure for multilayered scaling can be mathematically formulated as follows. Assume the transport coefficient in the baseline medium is μₜ₀, the albedo is α₀, and the exit weight of a specific photon is ω₀. It is further assumed that the multilayered medium has a total of n layers and the transport coefficient of the first layer in the medium is μₜ₁, that of the second layer is μₜ₂, . . . , and that of the nth layer is μₜₙ. Similarly, the albedo for each layer is α₁, α₂, . . . , αₙ, and the thickness of each layer is d₁, d₂, . . . , dₙ. For every photon that exits from the top surface of the baseline medium, the following steps can be performed:

I. Determine the corresponding locations of all the layer interfaces in the baseline medium. This step needs to be done only once for all photons. The thicknesses of these pseudolayers can be obtained by the following scaling operations:

$${d}_{1}^{′} = {d}_{1} \times \frac{{μ}_{t 1}}{{μ}_{t 0}} , \\ {d}_{2}^{′} = {d}_{2} \times \frac{{μ}_{t 2}}{{μ}_{t 0}} , \\ …$$

$${d}_{n}^{′} = {d}_{n} \times {μ}_{t n} / {μ}_{t 0} .$$

II. Determine the number of collisions that the photon experienced, Nᵢ, and the horizontal offset that the photon traveled, rᵢ, in each pseudolayer before exit based on the trajectory information from the baseline simulation (i=1, 2, . . . , n).

III. Scale the horizontal offset in each pseudolayer according to the transport coefficient of the corresponding real layer, and take the vector sum of the horizontal offsets in all layers, which yields the scaled exit distance

$$r = {\sum }_{i = 1}^{n} ( {r}_{i} \times \frac{{μ}_{t 0}}{{μ}_{ti}} ) ,$$

where rᵢ is the horizontal offset recorded in the ith pseudolayer.

IV. Calculate the weight change in each pseudolayer according to the albedo of each real layer and the number of collisions in each pseudolayer, and take the product of all the weight change terms, which yields the scaled exit weight:

$$w = {\prod }_{i = 1}^{n} {( \frac{{α}_{i}}{{α}_{0}} )}^{{N}_{i}} \times {w}_{0} ,$$

where Nᵢ is the number of collisions in each pseudolayer and ω₀ is the exit weight in the baseline simulation.

It should be pointed out that the horizontal offsets refer to either the x or the y dimension in a Cartesian coordinate system. To obtain the radial offsets, the offsets in the x and y dimensions should be scaled separately and then recombined in the end. Therefore, both x and y offsets are needed for scaling in a three-dimensional light transport model. In addition, when one random-walk step crosses two or more pseudolayers, the horizontal offset corresponding to this step should be distributed to all relevant layers according to the path length of the photon in each pseudolayer. For simplicity, it can be assumed that the baseline homogeneous medium and the bottom layer of the multilayered medium are semi-infinite in the axial dimension and infinite in the lateral dimension.

### II. Monte Carlo Baseline Simulation for Multilayered Scaling and Scaling Operation

A three-dimensional, weighted-photon Monte Carlo code written with standard American National Standards Institute (ANSI) C programming language (Liu et al., 2003; Wang et al., 1995) was modified to create a photon trajectory database for scaling. A single simulation was run for a homogeneous baseline medium, in which μₐ=0 cm⁻¹, μₛ=100 cm⁻¹, and the anisotropy factor g=0.9. The Henyey-Greenstein (HG) phase function was used for sampling scattering angles in the simulation. The refractive index of the medium above the baseline medium, the refractive index of the baseline medium, and the refractive index of the medium below the baseline medium were set at 1.462, 1.338, and 1.338, respectively. These two values represent the refractive indices of glass and water at 500 nm (Laven, 2003; Malittson, 1965). The thickness of the medium was set at 5 cm to simulate a semi-infinite medium.

A total of 4×10⁶ photons was launched at the origin of a Cartesian coordinate system to obtain the impulse response of the baseline medium in diffuse reflectance. The Cartesian coordinate system was set up such that the axial dimension, which is perpendicular to the top surface of the baseline medium, corresponds to the z axis, and the x-y plane is parallel to the top surface of the baseline medium. The angular profile of incident photons (relative to the z axis) followed a Gaussian distribution with a cutoff angle defined by a numerical aperture (NA) of 0.22 to simulate an optical fiber. The axial dimension of the baseline medium was empirically divided into 51 depth intervals with variable interval widths to record photon trajectory information. The interval width was progressively increased with depth because the likelihood of photon visitations decreases with depth. The actual depth interval width was assigned as follows: 50 μm for depths from 0 to 0.1 cm, 100 μm for depths from 0.105 to 0.475 cm, 350 μm for a depth of 0.485 cm, 500 μm for depths from 0.52 to 0.92 cm, 800 μm for a depth of 0.97 cm, and 1000 μm for depths from 1.05 to 1.85 cm. All depths beyond 1.95 cm are assigned to the last depth interval. When a photon exits at an angle relative to the z axis smaller than the cutoff angle defined by an NA of 0.22, the relevant trajectory information of this photon, which includes the exit weight, the x and y offsets, and the number of collisions of the photon within each depth interval, is stored in a numerical array. Approximately 1.2×10⁵ photons were detected on the top surface of the baseline medium, and a memory space of 160 MBytes was needed to store the trajectory data.

Because the depth intervals have finite width, the pseudolayer interfaces in the baseline medium, whose locations are obtained by scaling the depth of the layer interfaces in the multilayered medium, can be located within a depth interval rather than exactly at a boundary between two adjacent intervals. In this case, all the x and y offsets as well as the number of collisions corresponding to this interval need to be distributed between the two relevant pseudolayers. The contribution to each layer is linearly proportional to the fraction of the interval width within that layer.

After the impulse response of the multilayered medium in diffuse reflectance is obtained by using the scaling method, the diffuse reflectance for a specific fiber-optic source-detector geometry can be calculated by convolving the impulse response with the beam profile (Palmer & Ramanujam, 2006; Wang et al., 1995). All the scaling operations were coded and run in MATLAB 6 (Math-Works, Inc., Natick, Mass.).

### III. Theoretical Tissue Models and Specific Fiber-Optic Probe Geometries

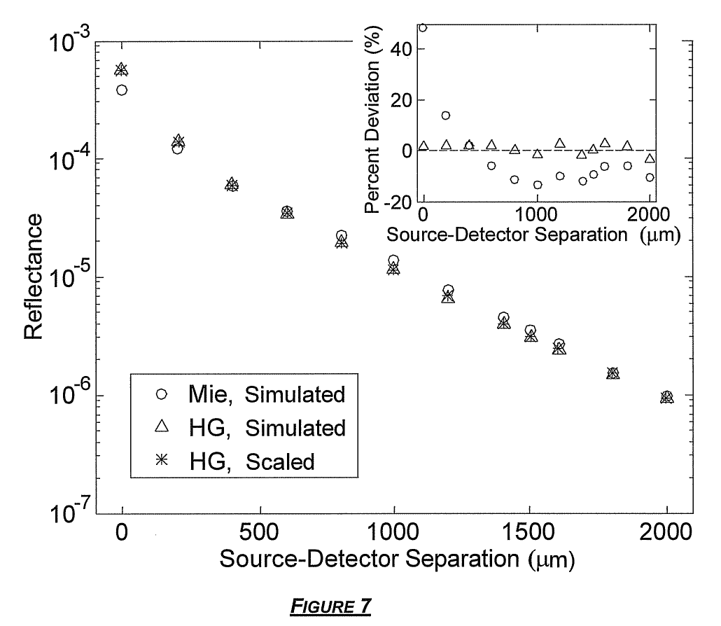

The scaling method was tested on a two-layered model and a three-layered model of human squamous epithelial tissue. The corresponding diffuse reflectance from the two epithelial tissue models was also independently simulated with a Monte Carlo code26 for comparison with the scaled diffuse reflectance. The HG function was used in the independent simulations except when the effect of the phase function was studied (see FIG. 7 and Tables 4 and 8).

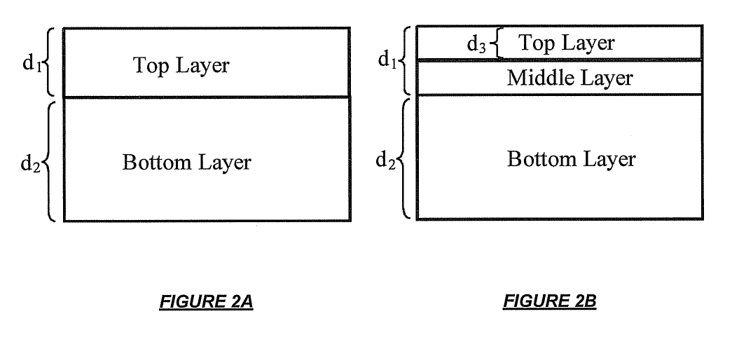

FIG. 2 shows the schematics of the two epithelial tissue models. In FIG. 2A, the top-layer thickness d₁ is 500 μm, and the bottom-layer thickness d₂ is 5 cm to simulate a semi-infinite medium. In FIG. 2B, the top layer thickness d₃ is varied from 50 to 250 and to 450 μm while the sum (d₁) of the top-layer and the middle-layer thicknesses is fixed at 500 μm. The middle layer in the three-layered model is intended to simulate a sublayer of neoplastic cells in the epithelial layer.

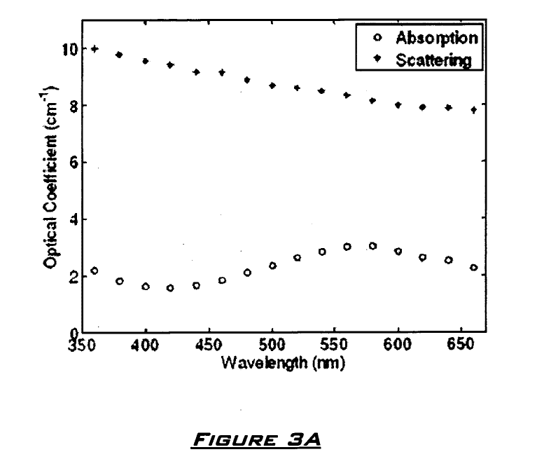

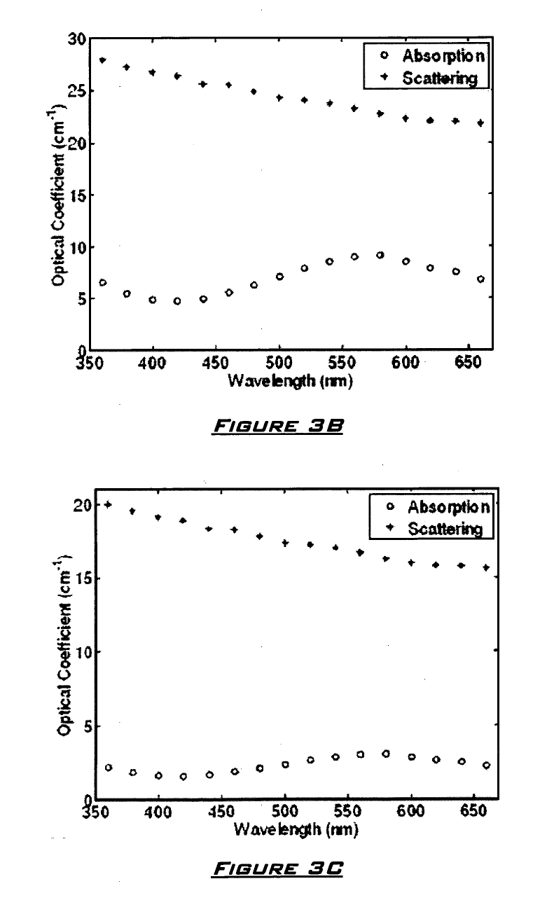

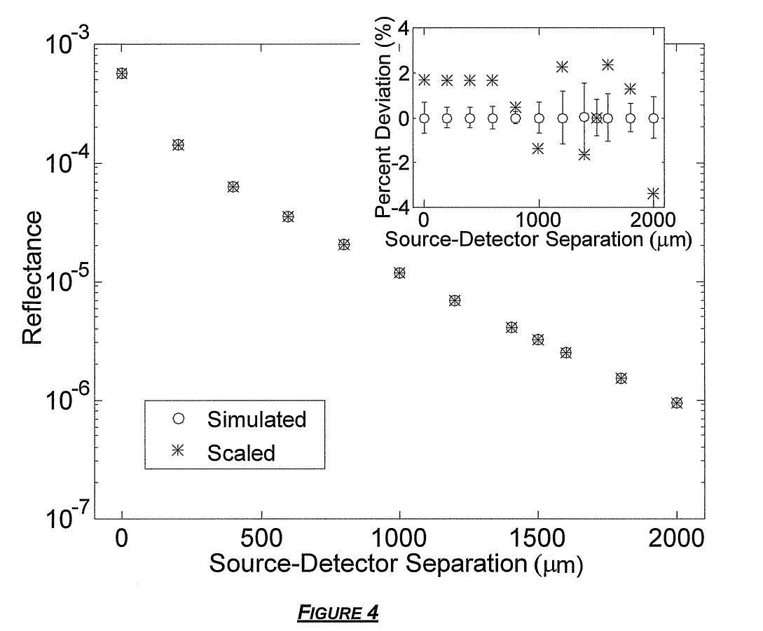

The optical properties of the tissue model are shown in FIG. 3A for the top layer, in FIG. 3B for the bottom layer, and in FIG. 3C for the middle layer. The optical properties of the top and bottom layers are exactly the same as those in a previous publication 16 from our group to facilitate comparison of the accuracy of optical property estimation later using the multilayered scaling method with the accuracy using the previously developed sequential estimation method (Liu & Ramanujam, 2006). The ranges of optical properties were chosen to represent those of human cervical tissue (Collier et al., 2003). The absorption coefficients of the middle layer are identical to those of the top layer, while the scattering coefficients of the middle layer are twice those of the top layer to approximate a precancerous layer (Collier et al., 2003). Absorption and scattering were assumed to be contributed, respectively, by Nigrosin at known concentrations and polystyrene spheres with a diameter of 1.053 μm and a volume concentration of 0.256%. Mie theory (Bohren & Huffman, 1983) was used to calculate the scattering properties of the polystyrene spheres. The refractive indices of the spheres and water were assumed to be 1.6 and 1.3352, respectively, in the calculation.

The refractive index of the medium above the tissue models, the refractive index of the tissue models, and the refractive index of the medium below the tissue models were 1.462, 1.338, and 1.338, respectively. The value of g was 0.9 unless specified otherwise. These parameters are maintained equal to those in the baseline simulation for scaling as described in the previous section to achieve “ideal conditions” for evaluation of scaled reflectance in Section IV hereinbelow. They will be varied to examine the valid range of scaled reflectance in Section V hereinbelow. The diameter of both source and detector fibers was 200 μm, and the NA was fixed at 0.22 for these simulations. The center-to-center distance between the source and the detector fibers was varied from 0 to 2000 μm with a uniform increment of 200 μm.

### IV. Accuracy of Scaled Reflectance Relative to Independently Simulated Reflectance under Ideal Conditions

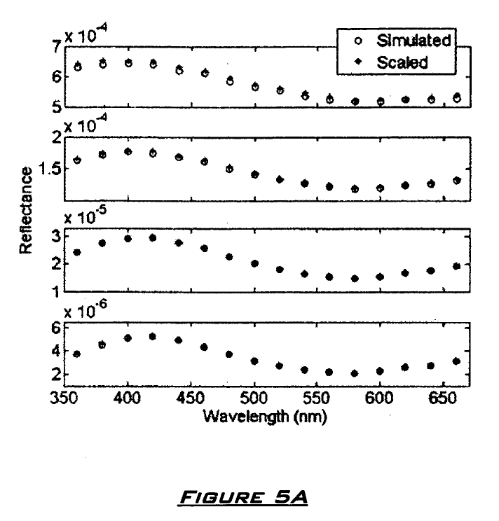

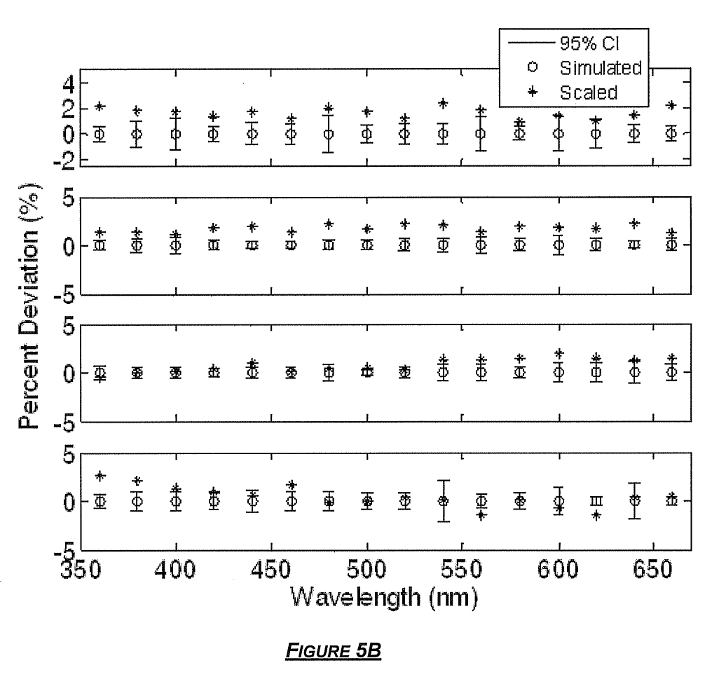

To test the accuracy of scaled diffuse reflectance under ideal conditions, the reflectance was independently simulated on the original two-layered epithelial model, in which the same anisotropy factor, refractive indices, and phase function as used in the baseline simulation were employed. Each independent simulation was run six times. The percent deviation between scaled and simulated results at each individual wavelength was calculated as follows to quantify the accuracy of the scaled results and is shown in FIGS. 4 and 5:

$$PercentDeviation = \frac{Scaled - Simulated}{Simulated} \times 100 , \qquad ( 1 )$$

where “Scaled” represents the scaled reflectance value and “Simulated” represents the mean of simulated reflectance values from six runs of the independent simulation on the same tissue model. The percent deviations of six simulated reflectance values relative to their mean were also calculated in the same manner. The 95% confidence interval (CI) of the percent deviations of simulated reflectance relative to their expected value was then estimated as follows:

95% CI=└mean−1.96×std/\sqrt{m},mean+1.96std/\sqrt{m}┘, (2)

where m is the number of simulation runs (m=6) and “mean” and “std” refer to the mean and standard deviation of the calculated percent deviations. It should be pointed out that the mean of the percent deviations is always zero and the 95% CI gives the range of the true percent deviation with a p-value of 0.05.

FIG. 4 shows scaled diffuse reflectance and independently simulated diffuse reflectance as a function of source-detector separation at a single wavelength (500 nm) for the original two-layered epithelial tissue model under ideal conditions, where the only source of error besides statistical uncertainty is the scaling operation. The two sets of symbols completely overlap at almost all separations, which indicates excellent agreement between simulated and scaled reflectance values. The inset graph shows the percent deviation of scaled reflectance calculated according to Equation (1) above. The 95% CIs of the percent deviations of simulated reflectance relative to their expected value are indicated by the error bars. All the percent deviations of the scaled reflectance are less than 4%; moreover, they are all close to or within the 95% CIs of the percent deviations of simulated reflectance values. On the one hand, small percent deviations of scaled reflectance relative to simulated reflectance are indicative of the validity of the multilayered scaling method. On the other hand, the observation that some data points representing the percent deviations of scaled reflectance are out of the 95% CI of percent deviations of simulated reflectance suggests that the scaling method may contain errors caused by factors other than statistical uncertainty, which are discussed hereinbelow in Section VIII.

FIG. 5A shows the simulated and scaled diffuse reflectance as a function of wavelength for four representative separations, which are 0, 200, 800, and 1500 μM, and FIG. 5B shows the percent deviation between scaled and simulated reflectance as a function of wavelength for the original two-layered epithelial model. It should be pointed out that a separation of 0 μm is the case in which a single fiber is used for both illumination and collection; a separation of 200 μm is the case in which source and detector fibers are placed side by side; a separation of 1500 μm represents a case in which source and detector fibers are placed far away from each other; and a separation of 800 μm is the case in between a small separation (0 μm) and a large separation (1500 μm). In FIG. 5A, the line shapes across four separations are similar because there was only one absorber present in the two-layered tissue model. The magnitude of reflectance decreases as the separation increases. The two sets of symbols representing scaled and simulated reflectance overlap completely when the separation is 800 or 1500 μm. The agreement is slightly worse when the separation is 0 or 200 μm.

In FIG. 5B, the percent deviation of the scaled reflectance relative to the mean of simulated reflectance and 95% CIs of the percent deviation of simulated reflectance from its mean are shown for comparison. The percent deviation between scaled and simulated reflectance is almost always outside of the 95% CI of the percent deviation of simulated reflectance and distributed monotonically on the positive side of the zero-deviation line when the separation is 0 or 200 μm. In contrast, over half of the percent deviations between scaled and simulated reflectance are within the 95% CI of the percent deviation of simulated reflectance and distributed evenly on the positive and negative sides of the zero-deviation line when the separation is 800 or 1500 μm. This finding suggested that the scaling method was better for larger source-detector separations than for smaller separations.

### V. Effect of Various Model Parameters on Percent Deviation of Scaled Diffuse Reflectance Relative to Simulated Diffuse Reflectance

Several parameters of the tissue models or probe geometry could affect the valid range of scaled diffuse reflectance when their values are different from those in the baseline simulation. For example, the variation in the anisotropy or refractive index values of the tissue model at different wavelengths can cause a change in diffuse reflectance even when the absorption and scattering coefficients are identical. If the multilayered scaling method, for which only a single set of values can be chosen for those parameters in the baseline simulation, is used to estimate optical properties for a range of wavelengths, such differences in model parameters could cause significant errors in the estimated optical properties. As the first step to evaluate the validity of scaled reflectance, a series of independent Monte Carlo simulations were run for several modified two-layered epithelial tissue models, in each of which one target parameter was varied over a certain range that covers typically seen values, while other parameters in the tissue model and the probe geometry were kept identical to those in the original two-layered epithelial tissue model. Then the differences between scaled reflectance and simulated reflectance were quantitatively evaluated. The root-mean-square error (RMSE) of scaled reflectance relative to independently simulated reflectance calculated over all wavelengths was used to quantify the difference between the simulated and scaled diffuse reflectance, which is defined as follows:

$$RMSE = \sqrt{\frac{{\sum }_{i = 1}^{n} {( \frac{{Scaled}_{i} - {Simulated}_{i}}{{Simulated}_{i}} \times 100 )}^{2}}{n}}$$

where n is the number of wavelengths (n=16) and Scaledᵢ and Simulatedᵢ correspond to scaled results and simulated results at the i^{th} wavelength, respectively.

V.A. Anisotropy Factor

Table 1 shows the RMSE of the scaled reflectance values for the original two-layered tissue model where the anisotropy was 0.9, relative to independently simulated reflectance for a modified two-layered epithelial tissue model. The simulated reflectance values for the modified two-layered tissue model were generated for the case where the anisotropy factor of the top layer and bottom layer was varied from 0.7 to 0.8 to 0.9 (this value was used in the baseline simulation) to 0.99 to cover the range of commonly seen anisotropy values in biological tissues (Cheong, 1995). It needs to be pointed out that when the anisotropy was varied in the modified tissue model the scattering coefficient was also changed accordingly to maintain an identical reduced scattering coefficient, in order to test the validity of the first-order similarity relation (Wyman et al., 1989). All other parameters in the modified and original tissue models remained identical.

TABLE 1
Effect of Anisotropy Factor of Tissue Layer on RMSE^{a}

| | | | | |
|---|---|---|---|---|
| | RMSE (%) | RMSE (%) | RMSE (%) | RMSE (%) |
| | for | for | for | for |
| | Separation = | Separation = | Separation = | Separation = |
| Variable | 0 μm | 200 μm | 800 μm | 1500 μm |

Top anisotropy

| | | | | |
|---|---|---|---|---|
| g = 0.7 | 20.0 | 4.2 | 9.5 | 7.4 |
| g = 0.8 | 9.5 | 1.7 | 5.1 | 3.8 |
| g = 0.9 | 1.7 | 1.7 | 1.0 | 1.2 |
| g = 0.99 | 12.3 | 3.4 | 3.7 | 3.6 |

Bottom anisotropy

| | | | | |
|---|---|---|---|---|
| g = 0.7 | 0.9 | 4.1 | 2.6 | 2.0 |
| g = 0.8 | 0.7 | 1.3 | 1.8 | 1.3 |
| g = 0.9 | 1.7 | 1.7 | 1.0 | 1.2 |
| g = 0.99 | 3.1 | 3.8 | 0.8 | 1.7 |

^{a}RMSEs of scaled reflectance for the original two-layered tissue model relative to independently simulated reflectance for a modified two-layered epithelial tissue model where the anisotropy factor (g) of the top or bottom layer was varied while other parameters of the modified tissue model were kept identical to those of the original tissue model. Note that the anisotropy factor was 0.9 in the original tissue model as shown in bold type.

For the top layer, it was found that the scaled reflectance for a separation of 0 μm deviates from the simulated reflectance most, which is consistent with the findings from FIG. 5. The RMSEs for a source-detector separation of 0 μm are significantly larger than those for larger separations for anisotropies of 0.7, 0.8, and 0.99. This suggested that the photons collected probably experienced many fewer collisions at a separation of 0 μm than at larger separations, thus requiring more precise anisotropy values to obtain accurate diffuse reflectance values. The RMSEs corresponding to g=0.9 were always the smallest while those corresponding to g=0.7 were always the largest, which implied that the further the anisotropy in an independent test simulation was from the baseline simulation for scaling, the larger the deviation between the scaled and simulated reflectance would be for all source-detector separations. The RMSEs for the bottom layer were generally smaller than those of the top layer for identical anisotropy values, which suggested that the diffuse reflectance was less affected by variation in the anisotropy of the bottom layer. Moreover, there was no clear trend with separation or anisotropy values in the RMSEs of the bottom layer.

V.B. Refractive Index of the Tissue Layers

Table 2 shows the RMSEs of the scaled reflectance values for the original two-layered epithelial tissue model where the refractive index was 1.338, relative to independently simulated reflectance for a modified two-layered epithelial tissue model where the refractive index of the top layer and the bottom layer was varied from 1.3 to 1.338 (the value used in the baseline simulation for scaling) to 1.4 and to 1.5 to cover the range of commonly seen refractive indices in biological tissues (Dirckx et al., 2005; Jiancheng et al., 2005; Tsenova & Stoykova, 2003; Tearney et al., 1995). All other parameters in the modified and original tissue models were kept identical.

TABLE 2
Effect of Refractive Index of Tissue Layer on RMSE^{a}

| | | | | |
|---|---|---|---|---|
| | RMSE (%) | RMSE (%) | RMSE (%) | RMSE (%) |
| | for | for | for | for |
| | Separation = | Separation = | Separation = | Separation = |
| Variable | 0 μm | 200 μm | 800 μm | 1500 μm |

Top refractive index

| | | | | |
|---|---|---|---|---|
| n = 1.3 | 2.9 | 1.6 | 1.1 | 1.0 |
| n = 1.338 | 1.7 | 1.7 | 1.0 | 1.2 |
| n = 1.4 | 8.4 | 5.8 | 3.1 | 3.5 |
| n = 1.5 | 17.0 | 10.2 | 6.5 | 6.3 |

Bottom refractive index

| | | | | |
|---|---|---|---|---|
| n = 1.3 | 0.9 | 1.3 | 3.6 | 4.7 |
| n = 1.338 | 1.7 | 1.7 | 1.0 | 1.2 |
| n = 1.4 | 2.5 | 5.1 | 8.2 | 8.1 |
| n = 1.5 | 1.2 | 6.8 | 20.2 | 19.6 |

^{a}RMSEs of scaled reflectance for the original two-layered tissue model relative to independently simulated reflectance for a modified two-layered epithelial tissue model where the refractive index of the top or bottom layer was varied while other parameters of the modified two-layered epithelial tissue model were kept identical to those of the original two-layered epithelial tissue model. Note that the refractive index was 1.338 in the original tissue model as shown in bold type.

When the top-layer refractive index was varied, the RMSE decreased in general as the source-detector separation increased. The RMSEs corresponding to n=1.338 were always the smallest while those corresponding to n=1.5 were always the largest, which suggested that the further the refractive index in an independent test simulation was from that in the baseline simulation, the larger the deviation between the scaled and simulated reflectance would be for all source-detector separations disclosed herein. When the bottom-layer refractive index was varied, a surprising finding was that the separation of 0 μm was always the best case among all separations in terms of the agreement between scaled and simulated reflectance. The RMSEs for small separations (0 and 200 μm) were generally smaller than those for the other two larger separations (800 and 1500 μm) for all refractive indices that were different from the baseline value. This suggested that the refractive index of the bottom layer did not considerably affect reflectance collected at small separations but could significantly affect reflectance collected at large separations, which was the opposite of the trend in the top layer. Except for a separation of 0 μm, the RMSE increased with the difference between the refractive index of the bottom layer and that in the baseline simulation.

V.C. Refractive Index of the Medium Above the Tissue Model

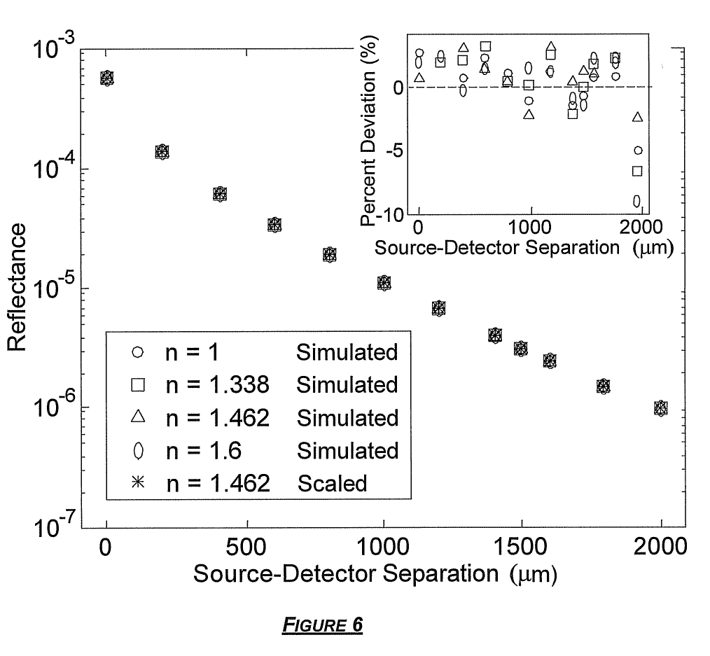

The medium above the tissue model could be air, water, or synthetic fused silica (the material that glass fibers are usually made of) in a simulation. FIG. 6 shows simulated and scaled reflectance as a function of the source-detector separation from a modified two-layered epithelial tissue model at a single wavelength (500 nm), where the refractive index of the medium above the tissue model was varied from 1.0 (air), to 1.338 (water), to 1.462 (synthetic fused silica), and to 1.6 (the upper limit of synthetic fused silica in the UV region; Malittson, 1965). The other parameters were kept identical to those of the original two-layered epithelial tissue model. The symbols corresponding to various refractive indices completely overlapped. The inset in FIG. 6, which gives the percent deviation of scaled reflectance relative to simulated reflectance, confirmed that the difference between simulated and scaled reflectance was smaller than 3% except for a separation of 2000 μm.

This suggested that the effect of the refractive index of the medium on top of the tissue model on detected diffuse reflectance was negligible compared with other variables that had been studied for separations smaller than 2000 μm. When the separation was equal to or larger than 2000 μm, the small number of photons collected by the detector fiber might cause more significant statistical uncertainty, and the effect of the refractive index of the medium above the tissue model could become more important. The same observation can be expected for other wavelengths as long as the optical properties are within a similar range.

V.D. Refractive Index of the Fiber Core

The refractive index of the fiber core could be another unknown in the simulation, which varies with wavelength but may not be conveniently measured. Considering that source and detector fiber tips usually occupy only a small area on the top surface of the tissue, the effect of the fiber core on those photons that hit the fiber core area and are then reflected back into the tissue were assumed to be negligible during photon propagation in the tissue model. Therefore, the problem was simplified by considering only photon launch from the source fiber end and photon collection on the detector fiber end. On the source end, the change in the refractive index of a fiber core can cause variations in the fraction of specular reflectance.

Table 3 lists the specular reflectance values calculated according to Fresnel's equation for (top half) 0° incidence and (bottom half) cutoff angles defined by an NA of 0.22 for various combinations of refractive indices of the fiber core (commonly seen refractive index values of synthetic fused silica (Malittson, 1965) in the UV-VIS spectral region) and the tissue model. It can be seen that the change in specular reflectance was negligible when the incident angle is varied from 0° to the cutoff angle defined by an NA of 0.22. In Table 3, the greatest specular reflectance occurred when n_{fiber}=1.6 and nₜᵢₛₛᵤₑ=1.3, in which case the specular reflectance was around 1%, and this percentage was comparable with the percent variation in diffuse reflectance due to statistical uncertainty shown in FIG. 4. This small specular reflectance suggested that the variations in the refractive index of the fiber core did not cause significant variation in the amount of light delivered into the tissue model for an NA equal to or smaller than 0.22.

TABLE 3
Effect of Refractive Indices on Fiber Core and
Tissue Model on Specular Reflectance^{a}

| | nₜᵢₛₛᵤₑ (row) | | |
|---|---|---|---|
| n_{fiber} (column) | 1.3 | 1.4 | 1.5 |

0° incidence

| | | | |
|---|---|---|---|
| 1.4 | 0.0041 | 6.3 × 10⁻³³ | 0.0012 |
| 1.5 | 0.0051 | 0.0012 | 0 |
| 1.6 | 0.011 | 0.0044 | 0.0010 |

Cutoff angles defined by NA 0.22

| | | | |
|---|---|---|---|
| 1.4 (θ_{cutoff} = 9.0°) | 0.0014 | 7.6 × 10⁻³³ | 0.0012 |
| 1.5 (θ_{cutoff} = 8.4°) | 0.0051 | 0.0012 | 0 |
| 1.6 (θ_{cutoff} = 7.9°) | 0.011 | 0.0044 | 0.0010 |

^{a}Fraction of specular reflectance for various combinations of refractive indices of the fiber core and the tissue model when (top half) the incident angle is 0° and (bottom half_the cutoff angle (θ_{cutoff}) is defined by an NA of 0.22. n_{fiber} represents the refractive index of the fiber core, and nₜᵢₛₛᵤₑ is the refractive index of the tissue model. The actual cutoff angles are also shown in the bottom half of the table.

On the detector end, the cutoff acceptance angle defined by an NA can be calculated by arcsin(NA/nₜᵢₛₛᵤₑ), where nₜᵢₛₛᵤₑ refers to the refractive index of the tissue model, which is independent of the refractive index of the fiber core if the NA is fixed. Therefore the refractive index of the fiber core has no impact on photon collection for a fixed NA.

V.E. Phase Function

The Henyey-Greenstein (HG) phase function and the Mie phase function are commonly used in Monte Carlo simulations of light transport in tissue. FIG. 7 shows the diffuse reflectance simulated for the Mie phase function used in both layers (calculated by Mie theory (Bohren & Huffman, 1983) for the polystyrene spheres in the theoretical phantom at 500 nm as described hereinabove), the diffuse reflectance simulated for the HG phase function with an anisotropy factor of 0.93 (equal to that of the Mie phase function) used in both layers, and the scaled reflectance for the original two-layered epithelial tissue model (the anisotropy factor was fixed at 0.9). The data presented in FIG. 7 demonstrated that the diffuse reflectance simulated with the Mie phase function was significantly different from that simulated with the HG phase function as well as from the scaled diffuse reflectance, especially for a separation of 0 μm (see the inset graph in FIG. 7). As the separation became larger, the percent deviation between the scaled reflectance and the diffuse reflectance simulated with the Mie phase function fluctuated and asymptotically approached a small value, which implied that the first-order similarity relation holds for large separations. In contrast, the percent deviation between the scaled reflectance and the diffuse reflectance simulated with the HG phase function always oscillated around zero.

Table 4 shows the RMSEs between scaled and simulated (HG versus Mie) reflectance for all 16 wavelengths for four representative separations. The diffuse reflectance simulated with the Mie phase function demonstrated considerably larger deviation compared with that simulated with the HG phase function for all separations, which suggested that the choice of the phase function was critical when diffuse reflectance in the UV-VIS spectral region for small source-detector separations was quantitatively modeled.

TABLE 4
Effect of Phase Function on RMSE^{a}

| | RMSE (%) | RMSE (%) | RMSE (%) | RMSE (%) |
|---|---|---|---|---|
| | for | for | for | for |
| | Separation = | Separation = | Separation = | Separation = |
| Variable | 0 μm | 200 μm | 800 μm | 1500 μm |
| HG | 1.7 | 1.7 | 1.0 | 1.2 |
| Mie | 40.0 | 13.5 | 10.1 | 9.3 |

^{a}RMSEs of scaled reflectance relative to independently simulated reflectance from a modified two-layered epithelial tissue model in the case that the phase function was changed from the HG function to the Mie function while other parameters of the modified two-layered epithelial tissue model were kept identical to those of the original two-layered epithelial tissue model. Note that the HG phase function was used in the baseline simulation for scaling.

### VI. Effect of Three Layers and Layer Thickness on Percent Deviation of Scaled Diffuse Reflectance Relative to Simulated Diffuse Reflectance

The RMSEs of scaled reflectance relative to corresponding independently simulated reflectance for a three-layered tissue model with the top layer at various thicknesses, whose structure and optical properties are shown, respectively, in FIGS. 2B and 3, are listed in Table 5. It should be noted that the only difference between the three-layered tissue model and the baseline simulation for scaling is the number of layers and optical properties. The purpose of this comparison was not only to test the validity of the multilayered scaling method for a tissue model with more layers but also to test whether a layer as thin as 50 μm in the tissue model, which is comparable with the smallest depth interval width and the mean transport free path in the baseline simulation, would cause a significant deviation between scaled and simulated reflectance.

TABLE 5
Effect of One Additional Layer and Layer Thickness on RMSE^{a}

| | | | | |
|---|---|---|---|---|
| | RMSE (%) | RMSE (%) | RMSE (%) | RMSE (%) |
| | for | for | for | for |
| | Separation = | Separation = | Separation = | Separation = |
| Variable | 0 μm | 200 μm | 800 μm | 1500 μm |

Top-layer thinkness (μm)

| | | | | |
|---|---|---|---|---|
| d₃ = 50 | 1.1 | 0.4 | 0.6 | 1.3 |
| d₃ = 250 | 1.7 | 1.4 | 0.5 | 2.8 |
| d₃ = 450 | 2.2 | 1.2 | 0.7 | 1.2 |

^{a}RMSEs of scaled reflectance relative to corresponding independently simulated reflectance for a three-layered epithelial tissue model, whose structure and optical properties were, respectively, shown in FIGS. 2B and 3. While the thickness of the top layer (d₃) was varied from 50 to 250 and to 450 μm, the thickness of the middle layer was changed from 450 to 250 and to 50 μm accordingly to keep the total thickness of the two layers a constant (500 μm). The anisotropy factor and refractive index of each layer as well as the choice of the phase function (HG) in the tissue model were identical to those in the baseline simulation for scaling.

It is observed that the RMSEs shown in Table 5 for the three-layered tissue model were generally comparable to those shown in Table 1 for the original two-layered tissue model with g=0.9. Additionally, the RMSEs for the three-layered tissue model with a 50 μm thick layer (when d₃=50 or 450 μm) were comparable to the RMSEs for the three-layered tissue model with the thickness of all layers significantly greater than 50 μm (when d₃=250 μm), which implied that a layer in a multilayered tissue model for which thickness was comparable to the smallest depth interval width and/or the mean transport free path in the baseline simulation for scaling did not cause the deviation between scaled diffuse reflectance and corresponding simulated reflectance to be considerably larger than thicker layers.

### VII. Effect of Anisotropy Factors, Refractive Indices, and Phase Functions on the Accuracy of Optical Property Estimation Using the Monte Carlo Reflectance Database Obtained with the Multilayered Scaling Method

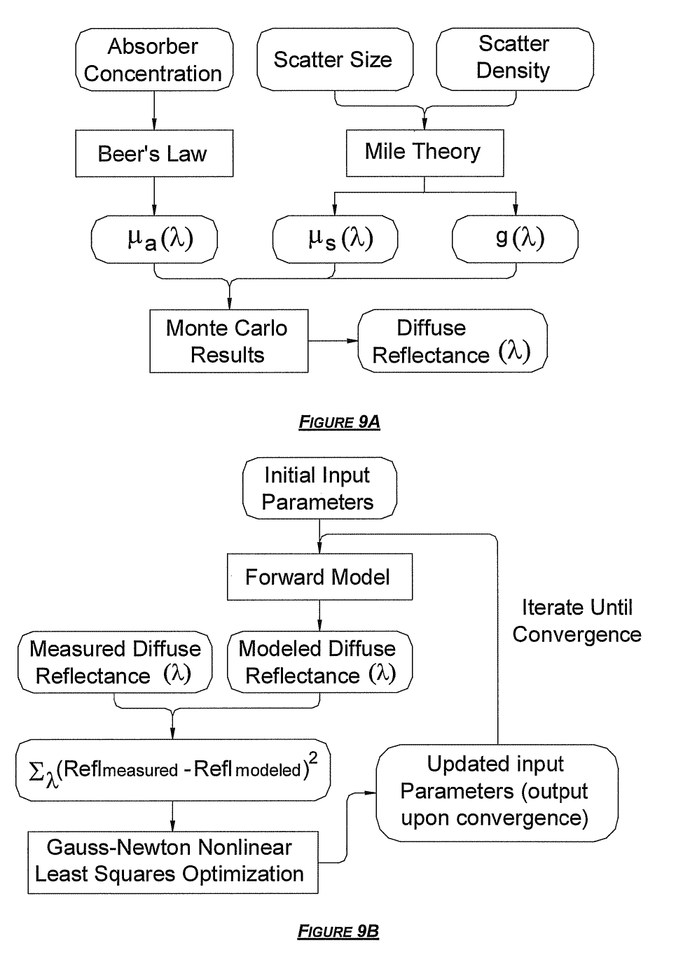

A purpose of the instant aspect of the presently disclosed subject matter was to examine how the deviations in the scaled diffuse reflectance relative to the independently simulated reflectance shown in Tables 1, 2, and 4 were propagated as errors in estimating the optical properties of a multilayered medium. As described previously (Liu & Ramanujam, 2006), the instant co-inventors have developed an approach called the sequential estimation approach to estimate the optical properties of a two-layered epithelial tissue-like medium. The optical properties of the first layer were determined from diffuse reflectance spectra obtained with a specialized angled probe geometry using a scalable Monte Carlo model as described in Palmer & Ramanujam, 2006 for a homogeneous medium. Then a second Monte Carlo model was employed to estimate the bottom layer optical properties and the top-layer thickness from diffuse reflectance spectra obtained with a standard flat-tip fiber-optic probe geometry. As described in Palmer & Ramanujam, 2006, a database that contained diffuse reflectance data obtained by running multiple independent simulations from the two-layered tissue model for a wide range of optical properties was required prior to the inversion process to estimate the optical properties for the bottom layer. FIGS. 9A and 9B illustrate the forward and inverse models described in Liu & Ramanujam, 2006 to which the presently disclosed subject matter can be applied. More particularly, FIG. 9A illustrates the forward model where a Monte Carlo simulation is performed using selected optical properties to determine diffuse reflectance of a top layer of a two layered tissue model using an angle probe geometry. FIG. 9B illustrates the inverse model that uses multiple iterations of the forward model and measured diffuse reflectance of a turbid medium as input until the error between the measured and modeled diffuse reflectance is minimized. Sub-sections A and B below describe the sequential estimation method illustrated in Liu & Ramanujam, 2006 to which the present subject matter can be applied.

VII.A. Monte Carlo-Based Model for Extraction of Optical Properties of the Top Layer in a Two-Layered Medium

A previously developed Monte Carlo model for a homogeneous medium (G. M. Palmer and N. Ramanujam, “Monte Carlo-based inverse model for calculating tissue optical properties. Part I: Theory and validation on synthetic phantoms,” Appl. Opt. 45, 1062-1071 (2006)) was used to extract absorption and scattering coefficients from the diffuse reflectance spectra obtained from the top layer of the two-layered tissue model with the angled probe geometry. The forward model has two sets of inputs, which are used to determine the absorption and scattering coefficients. The concentration (Cᵢ) of each chromophore (free parameter) and the corresponding wavelength dependent extinction coefficient [εᵢ(λ)] (fixed parameter) are used to determine the wavelength-dependent absorption coefficient [μₐ(λ)], according to the relationship μₐ(λ)=ΣIn(10)εᵢ(λ)Cᵢ. The Mie theory for spherical particles (A. Miller, MieTab program version 8.31, http://amiller.nmsu.edu/mietab.html) is used to model scattering. The scatterer size and density are free parameters and the refractive index is assumed to be known. The scattering coefficient [μₛ(λ)] and the anisotropy factor [g(λ)] are then calculated at a given wavelength. The optical properties, μₐ and μₛ, and the anisotropy factor, g, can then be input into a Monte Carlo simulation to obtain the diffuse reflectance at a given wavelength.

For the inverse model, an initial set of randomly selected free parameters is first input into the Monte Carlo-based forward model. These parameters include the absorber concentrations, the scatterer size, and density. The wavelength-dependent extinction coefficients of the absorber, and the refractive index mismatch of the scatterer are fixed. These input parameters are used in the forward model to generate a predicted reflectance. Then the sum of the square of the differences between the predicted and the actual measured reflectance spectra (i.e., sum of the square of errors) is computed. The input parameters are iteratively updated until the sum of the square of errors reaches a global minimum. A Gauss-Newton nonlinear least-squares algorithm provided in the MATLAB optimization toolbox (MathWorks, Incorporated, Natick, Mass.) was used for the minimization scheme.

In order to increase the efficiency of the Monte Carlo simulations (in the forward part of the model), a scaling approach previously described by Graaff et al. (R. Graaff, M. H. Koelink, F. F. M. de Mul, W. G. Zijlstra, A. C. M. Dassel, and J. G. Aarnoudse, “Condensed Monte Carlo simulations for the description of light transport,” Appl. Opt. 32, 426-434 (1993)) was incorporated such that only a single

Monte Carlo simulation with an impulse incident beam needs to be run, the output of which can be scaled for a wide range of absorption and scattering coefficients. The parameters of the single Monte Carlo simulation were as follows: μₐ=0 cm⁻¹,
μₛ=150 cm⁻¹, g=0.9. The number of incident photons was 4×10⁷. In order to adapt this method for use with a probe geometry, convolution was used to integrate over the illumination and collection areas of the geometry to determine the probability that a photon, launched from a finite illumination area, would be collected within a specific collection area assuming spatial invariance.

VII.B. Monte Carlo-Based Model for Extraction of Optical Properties of a Two-Layered Medium

A two-layered Monte Carlo model was then used to extract the optical properties of the bottom layer and the thickness of the top layer of the two-layered tissue model, from the diffuse reflectance spectrum obtained with the flat-tip probe geometry. This model assumes that the optical properties of the top layer are known from the previous step. In the forward model, Beer's law was used to calculate the absorption coefficient of the bottom layer given the absorber concentration and wavelength-dependent extinction coefficient; Mie theory was used to determine the

scattering coefficient of the bottom layer given the scatterer size, density, and refractive index mismatch. Next the optical properties of the two layers and the thickness of the top layer were used as inputs into the two-layered Monte Carlo model to generate a predicted diffuse reflectance. The inversion approach used was the same as that described in Subsection B, except that the optical properties being retrieved were for the bottom rather than the top layer, and the thickness of the top layer was included as an additional free parameter.

A different approach was used to increase the efficiency of the two-layered forward Monte Carlo model. Specifically, a series of baseline Monte Carlo simulations were run ahead of time to generate a database of diffuse reflectance values for a two-layered medium for zero absorption and a wide range of scattering coefficients of the top and bottom layers. For each scattering coefficient pair (top and bottom layers), simulations were carried out for a range of thicknesses. Table 6 shown below lists the reduced scattering coefficients and thicknesses of the top and bottom layers used in the baseline simulations to generate the Monte Carlo database for two-layered media.

TABLE 6
Scattering Coefficients and Thicknesses of the Top and
Bottom Layers Used in the Baseline Simulations to Generate the
Monte Carlo Database for Two-Layered Media^{a}

| | Top Layer | Bottom Layer |
|---|---|---|
| Reduced scattering | 3, 3.67, 4.48, 5.48, | 14, 17.11, 20.91, |
| coefficient, μₛ′ (cm⁻¹) | 6.69, 8.18, | 25.56, 31.24, |
| | 10.00, 12.22, | 38.18, 46.67 |
| | 14.94 | |
| Thickness (μm) | 0, 50, 100, 150, | 30 000 |
| | 200, 250, 300, | |
| | 350, 400, 500, | |
| | 600, 700, 800 | |

^{a}The anisotropy factor was 0.9, and the absorption coefficient was zero in all simulations. All combinations of these parameters were simulated.

The anisotropy factor was 0.9, and the absorption coefficient was zero in all simulations. All combinations of the listed parameters were used. A total of 819 independent simulations were run, each with 1×10⁷ incident photons. To reduce the variance of the detected diffuse reflectance, photons were collected over a ring area around the central axis of the illumination fiber, the radial thickness of which was equal to the diameter of the collection fiber. During each simulation, the path length of every detected photon in each of the two layers was recorded. The diffuse reflectance as a function of the radial distance of the photon's exit location was then scaled for a given absorption coefficient using Beer's law (which is a function of the absorption coefficient and the path length; Kienle & Patterson, “Determination of the optical properties of turbid media from a single Monte Carlo simulation,” Phys. Med. Biol. 41, 2221-2227 (1996)) and for the actual fiber collection area. Linear interpolation was used to calculate the diffuse reflectance for optical properties or thicknesses not contained in the database. The results were compared to those directly obtained from independent simulations to validate the accuracy of this approach.

In the presently disclosed subject matter, the computationally intensive process of running multiple independent simulations is replaced by using the multilayered scaling method. In the process of implementing the inversion, the optical properties of the top layer were assumed as known. The deviation between estimated and true optical properties for the wavelength range of interest was represented by the RMSE.

VII.C. Results Using Scaling Method

Tables 7-9 list the RMSEs of estimated optical properties of the bottom layer and thickness of the top layer relative to the corresponding true values for given simulated diffuse reflectance spectra at a source-detector separation of 1500 μm from the same modified two-layered epithelial tissue models used in Tables 1, 2, and 4. It can be seen in Tables 7-9 that the RMSEs in the case where the anisotropies, refractive indices, and the phase functions of the two-layered tissue model were identical to those used in the baseline simulation were comparable to those obtained previously using a Monte Carlo database created with independently simulated data (Liu & Ramanujam, 2006) for the same two-layered tissue model and probe geometry. Other results are discussed in Section VIII hereinbelow.

TABLE 7
Effect of Anisotropy Factor of Tissue Layer on RMSE
of Estimated Optical Properties^{a}

| | Thickness of | | | RMSE (%) > |
|---|---|---|---|---|
| Variable | Top Layer | μₐ_{_{—}}_{bottom} | μ′ₛ_{_{—}}_{bottom} | 20%? |

Top anisotropy

| | | | | |
|---|---|---|---|---|
| g = 0.7 | −12.7 | 10.5 | 45.2 | Y |
| g = 0.8 | −11.5 | 9.6 | 15.5 | |
| g = 0.9 | 9.6 | 9.5 | 5.9 | |
| g = 0.99 | −6.2 | 10.5 | 8.4 | |

Bottom anisotropy

| | | | | |
|---|---|---|---|---|
| g = 0.7 | −9.0 | 8.3 | 12.8 | |
| g = 0.8 | −26.6 | 21.3 | 7.7 | Y |
| g = 0.9 | 9.6 | 9.5 | 5.9 | |
| g = 0.99 | −10.2 | 12.1 | 6.5 | |

^{a}RMSEs of the estimated thickness of the top layer and optical properties of the bottom layer relative to the corresponding true values for given sets of simulated diffuse reflectance spectra from the same modified two-layered epithelial tissue models as in Table 1, where the anisotropy factor of the top or bottom layer was varied while other parameters in the modified two-layered epithelial tissue models were kept identical to those in the original two-layered epithelial tissue model. The rows with bold type are the RMSEs of estimated parameters for input diffuse reflectance simulated with exactly the same anisotropy factor as in the baseline simulation for scaling. The rightmost column in the table indicates if a row contains an RMSE greater than 20% (marked by “Y”), which is a sign of inaccurate inversion.

TABLE 8
Effect of Refractive Index of Tissue Layer on RMSE
of Estimated Optical Properties^{a}

| | Thickness of | | | RMSE (%) > |
|---|---|---|---|---|
| Variable | Top Layer | μₐ_{_{—}}_{bottom} | μ′ₛ_{_{—}}_{bottom} | 20%? |

Top refractive index

| | | | | |
|---|---|---|---|---|
| n = 1.3 | 6.3 | 2.1 | 25.0 | Y |
| n = 1.338 | 9.6 | 9.5 | 5.9 | |
| n = 1.4 | −7.5 | 7.8 | 45.4 | Y |
| n = 1.5 | −7.1 | 7.1 | 76.3 | Y |

Bottom refractive index

| | | | | |
|---|---|---|---|---|
| n = 1.3 | 4.2 | 1.4 | 28.8 | Y |
| n = 1.338 | 9.6 | 9.5 | 5.9 | |
| n = 1.4 | −14.5 | 6.9 | 2.5 | |
| n = 1.5 | −11.6 | 6.0 | 14.3 | |

^{a}RMSEs of the estimated thickness of the top layer and optical properties of the bottom layer relative to the corresponding true values for given sets of simulated diffuse reflectance spectra from the same modified two-layered epithelial tissue models as in Table 2, where the refractive index of the top or bottom layer was varied while other parameters in the modified two-layered epithelial tissue models were kept identical to those in the original two-layered epithelial tissue model. The rows with bold type are the RMSEs of estimated parameters for input diffuse reflectance simulated with exactly the same refractive index as in the baseline simulation for scaling. The rightmost column in the table indicates if a row contains an RMSE greater than 20% (marked by “Y”), which is a sign of inaccurate inversion.

TABLE 9
Effect of Phase Function on RMSE of
Estimated Optical Properties^{a}

| | Thickness of | | | RMSE (%) > |
|---|---|---|---|---|
| Variable | Top Layer | μₐ_{_{—}}bottom | μ′ₛ_{_{—}}bottom | 20%? |
| HG | 9.6 | 9.5 | 5.9 | |
| Mie | −30 | 31.4 | 5.0 | Y |

^{a}RMSEs of the estimated thickness of the top layer and optical properties of the bottom layer relative to the corresponding true values for given sets of simulated diffuse reflectance spectra from the same modified two-layered epithelial tissue models as in Table 4, where the phase function was changed from the HG function to the Mie function while other parameters in the modified two-layered epithelial tissue models were kept identical to those in the original two-layered epithelial tissue model. The rows with bold type are the RMSEs of estimated parameters for input diffuse reflectance simulated with exactly the same phase function as in the baseline simulation for scaling. The rightmost column in the table indicates if a row contains an RMSE greater than 20% (marked by “Y”), which is a sign of inaccurate inversion.

### VIII. Exemplary System

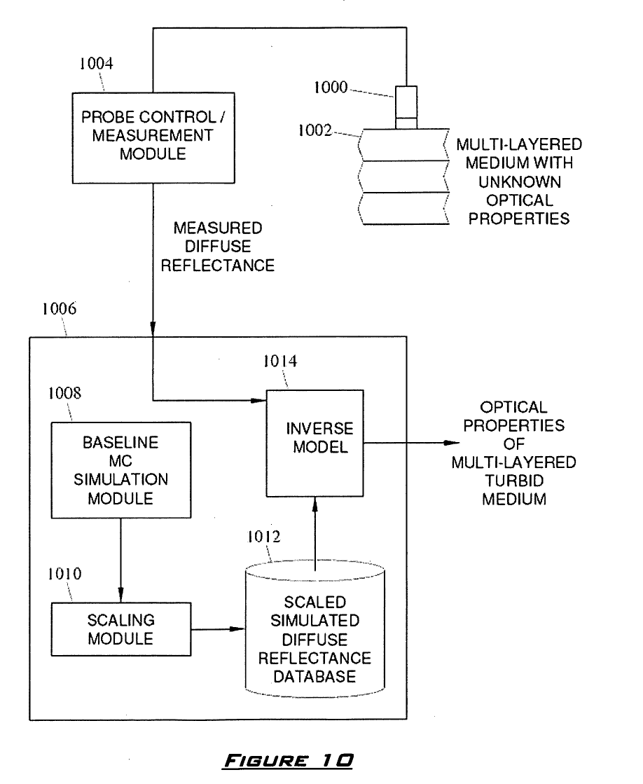

FIG. 10 is a block diagram illustrating an exemplary system for determining optical properties of a multi-layered turbid medium from measured diffuse reflectance using the scaling method described herein for performing the forward Monte Carlo simulation. Referring to FIG. 10, a probe 1000 may be used to illuminate a multi-layered turbid medium 1002 and collect reflected light. Probe 100 may be controlled by a probe control/measurement module 1004 that includes hardware and software for generating and controlling the excitation light, receiving the reflected light detected by the collection fibers and outputting an indication of diffuse reflectance. Exemplary spectroscopic probes suitable for use with embodiments of the subject matter described herein for multilayered media are described in Liu & Ramanujam, 2006. The output from probe control/measurement module 1004 is measured diffuse reflectance from turbid medium 1002.

One or more computers 1006 may include a baseline Monte Carlo simulation module 1008 for performing the baseline Monte Carlo simulation described herein. A scaling module 1010 may scale the photon projectories and exit weights from the baseline Monte Carlo simulation to create a database 1012 of scaled simulated diffuse reflectance values for different sets of optical properties. The measured diffuse reflectance and the scaled simulated diffuse reflectance values may be input into an inverse model 1014 that iteratively determines the optical properties of the in layered turbid medium, for example, using the inverse model described in Liu & Ramanujam, 2006 referenced above. Inverse model 1014, scaling module 1010, and simulation module 1008 may be hardware, software, and/or firmware components for performing the functions described herein.

### IX. Summary

The presently disclosed subject matter relates to multilayered scaling methods that allow for implementation of fast Monte Carlo simulations of diffuse reflectance from multilayered turbid media. The disclosed methods employ photon trajectory information provided by only a single baseline simulation, from which the diffuse reflectance can be computed for a wide range of optical properties in a multilayered turbid medium. A convolution scheme is also incorporated to calculate diffuse reflectance for specific fiber-optic probe geometries. The multilayered scaling approach for computing diffuse reflectance was demonstrated for a two-layered and a three-layered epithelial tissue model and validated by quantitatively comparing scaled results with diffuse reflectance obtained from independent Monte Carlo simulations. In addition, a diffuse reflectance spectrum simulated from the two-layered tissue model for a source-detector separation of 1500 μm was used as the input to the sequential estimation method (Liu & Ramanujam, 2006) described previously to evaluate the errors in retrieving the optical properties of the bottom layer and the thickness of the top layer of the tissue model where a Monte Carlo database created by the multilayered scaling method was employed in the inversion (assuming that the optical properties of the top layer are known).

As such, multilayered scaling methods employable to quickly calculate diffuse reflectance for a wide range of optical properties based on a single baseline Monte Carlo simulation are disclosed herein. For example, a single Monte Carlo simulation with 10⁷ incident photons for the two-layered tissue model shown in FIG. 2A took 1-2 hours in a Sun Unix workstation with a 1 GHz ULTRASPARC®-IIIi CPU and 1 GByte RAM when the HG phase function was used. The baseline simulation for scaling described herein was run with 4×10⁶ incident photons, which took about 35 hours on the same type of computer. After the photon trajectory information was obtained from the baseline simulation, it took about 4 seconds to scale for the two-layered tissue model and 5 seconds for the three-layered tissue model shown in FIG. 2. The multilayered scaling method thus reduced the computation time by more than 2 orders of magnitude compared with independent Monte Carlo simulations.

The multilayered scaling method could be further optimized, for example by applying parallel computation, to achieve even faster computation than specifically disclosed herein. The multilayered scaling method can also be easily extended to more complicated probe geometries, for example, a probe geometry with oblique illumination and collection (Liu & Ramanujam, 2006; Liu & Ramanujam, 2004). Requiring only one baseline simulation makes the disclosed methods particularly suited to simulating diffuse reflectance spectra in a multilayered medium for a wide range of optical properties and for a variety of different probe geometries and/or for creating a Monte Carlo database for estimating optical properties of layered media, which can facilitate the increased use of Monte Carlo modeling in spectroscopy research of layered tissues.

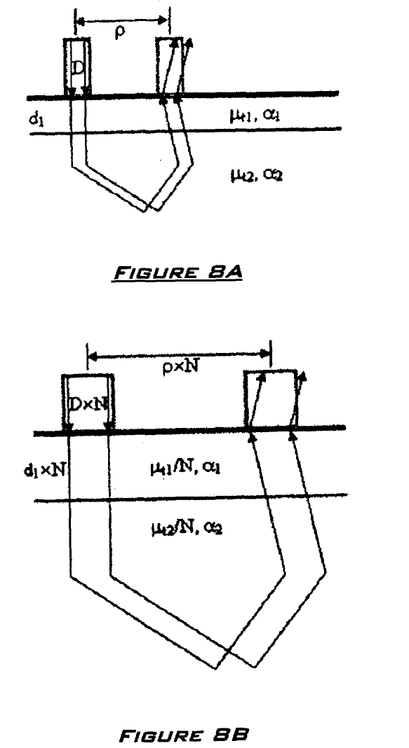

The scaling relations disclosed herein can also play a role in simplifying phantom fabrication. FIG. 8A shows a flat-tip fiber-optic probe geometry for diffuse reflectance measurement from a semi-infinite two-layered epithelial tissue phantom, and FIG. 8B shows the scaled version of the phantom and the probe geometry. The physical dimensions of both the phantom and the fiberoptic probe were scaled up by a factor of N while the transport coefficients of the phantom were scaled down by the same factor in the scaled version. It is straightforward to see that the diffuse reflectance measured in FIGS. 8A and 8B would be identical as can be inferred from the two representative scaled trajectories, which has also been confirmed by actual diffuse reflectance calculation for the two phantoms using the multilayered scaling method.

One example of applications for the scaled phantom is to replace a phantom whose top-layer thickness d₁ is very small with a scaled phantom whose top layer is much thicker. By scaling up the dimensions of the phantom and the probe as shown in FIG. 8B, identical diffuse reflectance can be measured from the scaled phantom in which the thickness of the top layer is N times the original thickness and thus easier to make. Similar approaches can be used to scale other parameters to make them easier to achieve when the phantom with raw parameters is not feasible to fabricate. It should be noted that when the same scatterer is used in the raw phantom and in the scaled phantom, the variation in the dimension of the phantom and the probe can cause a change in the validity of a simplified phase function: e.g., using the HG phase function with an identical anisotropy factor to replace the Mie phase function is not accurate for small source-detector separations but is accurate for large separations.

Although the difference between scaled and simulated reflectance is small under the conditions shown in FIGS. 4 and 5, the data presented in FIG. 4 inset and FIG. 5B demonstrated that scaled reflectance was slightly out of the 95% CI of simulated reflectance that was determined by the statistical uncertainty. Besides the difference in the number of incident photons between test simulations and the baseline simulation for scaling, the main reason for this observation was that the photon trajectory information can only be recorded in several depth intervals with finite widths. When the layer interface in a two-layered tissue model was mapped to the baseline homogeneous model for scaling, the interface would fall either exactly at a boundary between two adjacent depth intervals or within a depth interval. In the former case, the scaling result would be identical to the simulated result from an equivalent independent Monte Carlo simulation. However, a systematic error might be induced in the latter case if the offset and number of collisions in this depth interval were distributed between the two relevant pseudolayers and the contribution to each layer were proportional to the fraction of the interval width within that layer.

This step assumes that the offset and number of all collisions are uniformly distributed within a depth interval, which might not always be true in an independent simulation. A scheme that records the photon density as a function of depth at a finer resolution to more precisely determine this distribution might improve the accuracy. Alternatively, smaller depth interval widths in the most populated region of photon visitation could be chosen to reduce this potential error. As a rule of thumb, an interval width that is comparable to the mean transport free path in the baseline simulation for the depth within 1000 μm would yield an acceptable systematic error as demonstrated in FIGS. 4 and 5. Given that finer depth intervals require more memory space to store the photon trajectory information, a scheme of variable depth interval widths described herein (refer to Section II for details) can be used as a trade-off. In addition, certain variance reduction techniques, such as geometry splitting (Liu & Ramanujam, 2006; X-5 Monte Carlo Team, 2003) can be used to increase the number of useful photons in scaling, thus reducing the statistical uncertainty of scaled results when a narrow range of optical properties and source-detector separations are evaluated.

Tables 1, 2, and 4 show the RMSEs of scaled reflectance relative to independently simulated reflectance in the case where one model parameter was changed at a time. It can be seen that the RMSE value can vary over a large range depending on which parameter is changed. The validity of scaled results can depend upon the accuracy requirement of specific applications when the target layered tissue model contains parameters whose values are not equal to the baseline ones. For example, if one needs to see only the general trend of forward diffuse reflectance spectra for a certain fiber-optic geometry, perhaps a RMSE of 10% will be tolerable. However, if the multilayered scaling result is used to create a Monte Carlo database for inversion to estimate optical properties, a smaller RMSE might be required. For a two-layered epithelial tissue model in general,

(1) Diffuse reflectance can be more sensitive to the anisotropy factor of the top layer than to the anisotropy of the bottom layer when the HG phase function is used in the baseline simulations. This might be attributed to the fact that photons are multiply scattered before they reach the bottom layer. Moreover, the diffuse reflectance obtained at a small separation (0 μm) can be more sensitive to the anisotropy factor of the top layer than those measured at larger separations (200, 800, and 1500 μm) for a similar reason: i.e., photons have been multiply scattered upon detection for larger separations. Similar trends are not observed for the bottom layer.

(2) Diffuse reflectance simulated for small source-detector separations (0 and 200 μm) can be more sensitive to the refractive index of the top layer while diffuse reflectance simulated for large separations (800 and 1500 μm) can be more sensitive to the refractive index of the bottom layer, which can be explained as follows.

When the refractive index of the top layer changes, refractive index mismatch can occur at both the interface between the medium above the tissue model and the top layer and the interface between the top and bottom layers. The photons detected for small source-detector separations primarily travel in the top layer so the diffuse reflectance collected for small separations is primarily influenced by the refractive index mismatch between the top layer and the medium above it. When the refractive index of the bottom layer changes, the diffuse reflectance collected for small separations can be influenced only minimally because the detected photons primarily travel in the top layer. However, the diffuse reflectance collected at the larger separations can be influenced more significantly by the refractive index of the bottom layer because the detected photons are more likely to travel within this part of the tissue.

(3) Diffuse reflectance for all source-detector separations disclosed herein (0, 200, 800, 1500 μm) can be sensitive to the choice of the phase function. For applications that require high accuracy in diffuse reflectance, such as precise estimation of optical properties in layered media, the high-order moments of the phase function can be considered for these separations (Bevilacqua & Depeursinge, 1999; Bevilacqua et al., 1999).

In the study of using the multilayered scaling method for inversion described in Section VII hereinabove, it can be difficult to correlate the RMSEs in diffuse reflectance as shown in Tables 1, 2, and 4 with the RMSEs in estimated parameters as shown in Tables 6-8, potentially because of the interplay among three free parameters and the statistical uncertainty of simulated results. For example, while Table 1 demonstrates that the anisotropy factor in the bottom layer had a smaller effect on diffuse reflectance than that in the top layer did, the RMSEs in estimated optical properties in Table 6 did not necessarily agree with that if all three free parameters were considered simultaneously. It has also been found that when the number of free parameters was reduced from three to two and then to one, the RMSEs of estimated parameters became much smaller and the correlation between the RMSE of forward diffuse reflectance and that of estimated parameters improved progressively.

Another important finding is that the RMSEs in estimated parameters were in general considerably larger than those in forward diffuse reflectance. For example, when the anisotropy factor was 0.8 in the bottom layer, the RMSE of the forward diffuse reflectance for the separation of 1500 μm was 1.3% in Table 1, which was comparable to the RMSEs of diffuse reflectance for g=0.9 and g=0.99. In contrast, the RMSEs of estimated optical properties for g=0.8 were considerably larger than those for g=0.9 and g=0.99 in Table 6. This special case suggested that a small deviation in the forward reflectance due to the change in one parameter of the tissue model could result in a much larger error in estimated optical properties. This observation highlights the need of accurate light transport modeling for the estimation of optical properties in the UV-VIS region for source-detector separations smaller than 2000 μm when there are several free parameters but only limited data.

Because a scaled result can be obtained by applying the scaling operation to the photon trajectory data generated by the baseline Monte Carlo simulation, its accuracy can depend on both the scaling operation and the baseline Monte Carlo simulation. The errors induced by the two sources seemed to be independent of each other. Thus, the convergence of the proposed method can depends on the number of detected photons (i.e., the standard deviation of diffuse reflectance is proportional to the square root of number of detected photons). Although the presently disclosed subject matter demonstrated that the multilayered scaling method worked for a layered tissue model with layer thicknesses as thin as one half of the mean transport free path and source-detector separations as large as 40 mean transport free paths, the validity of the method for a specific problem can be empirically evaluated (for example, in the near infrared wavelength range where the source-detector separations are significantly greater than those disclosed herein).

Summarily, multilayered scaling methods are disclosed herein that are capable of calculating diffuse reflectance for a wide range of optical properties based on the photon trajectory information generated from a single baseline Monte Carlo simulation, which can dramatically reduce the computation time of using Monte Carlo modeling for spectroscopy studies of layered media. These methods were tested on both two-layered and three-layered epithelial tissue models. The deviation between scaled diffuse reflectance and independently simulated diffuse reflectance was comparable to the statistical variation between simulated diffuse reflectances from repeated independent simulations.

Moreover, the scaling method was used to create a Monte Carlo database for a two-layered tissue model. The database was then employed to estimate the optical properties of the bottom layer and the thickness of the top layer for given simulated diffuse reflectance spectra from the two-layered epithelial tissue model. It was found that the accuracy of estimated parameters was comparable to that achieved previously using another Monte Carlo database that was constructed with independently simulated Monte Carlo data. The scaling method disclosed herein is particularly suited to simulating diffuse reflectance spectra or creating a Monte Carlo database to estimate optical properties of layered media, which can potentially help expand the use of Monte Carlo modeling in the spectroscopy studies of layered tissues.

### REFERENCES

All references listed below, as well as all references cited in the instant disclosure, including but not limited to all patents, patent applications and publications thereof, scientific journal articles, and web pages, are incorporated herein by reference in their entireties to the extent that they supplement, explain, provide a background for, or teach methodology, techniques, and/or compositions employed herein.
Battistelli et al., J. Opt. Soc. Am. A 2,903-911 (1985).
Bevilacqua & Depeursinge, J. Opt. Soc. Am. A 16, 2935-2945 (1999).
Bevilacqua et al., Appl. Opt. 38, 4939-4950 (1999).
Bohren & Huffman, Absorption and Scattering of Light by Small Particles, John Wiley & Sons, Inc. (1983).
Cheong, “Appendix to Chapter 8: summary of optical properties,” in Optical-Thermal Response of Laser-Irradiated Tissue, Welch & van Gemert (eds.), pp. 275-303, (Plenum, 1995).
Collier et al., IEEE J. Sel. Top. Quantum Electron. 9, 307-313 (2003).
Dirckx et al., J. Biomed. Opt. 10, 44014 (2005).
Doornbos et al., Phys. Med. Biol. 44, 967-981 (1999).
Drezek et al., J. Biomed. Opt. 6, 385-396 (2001).
Drezek et al., Photochem. Photobiol. 73, 636-641 (2001).
Farrell et al., Med. Phys. 19, 879-888 (1992).
Graaff et al., Appl. Opt. 32, 426-434 (1993).
Hayakawa et al., Opt. Lett. 26, 1335-1337 (2001).
Jiancheng et al., Appl. Opt. 44, 1845-1849 (2005).
Kienle & Patterson Phys. Med. Biol. 41, 2221-2227 (1996).
Kienle et al., Appl. Opt. 35, 2304-2314 (1996).
Laven, “Refractive index of water as a function of wavelength,” available online via the website of Philip Laven of Geneva, Switzerland (2003).
Liu & Ramanujam, Appl. Opt. 45, 4776-4790 (2006).
Liu & Ramanujam, Opt. Lett. 29, 2034-2036 (2004).
Liu et al., J. Biomed. Opt. 8,223-236 (2003).
Malittson, “Refractive index versus wavelength reference table measured at 20° C.: synthetic fused silica, available online via the website of Polymicro Technologies of Phoenix, Ariz. (1965).
Merritt et al., Appl. Opt. 42, 2951-2959 (2003).
Palmer & Ramanujam, Appl. Opt. 45, 1062-1071 (2006).
Palmer et al., Appl. Opt. 45, 1072-1078 (2006).
Pavlova et al., Photochem. Photobiol. 77, 550-555 (2003).
Ramanujam et al., Opt. Express 8, 335-343 (2000).
Sassaroli et al., Appl. Opt. 37, 7392-7400 (1998).
Swartling et al., J. Opt. Soc. Am. A 20, 714-727 (2003).
Tearney et al., Opt. Lett. 20, 2258-2260 (1995).
The Condor Team, “Condor-high throughput computing, (available online from the University of Wisconsin website; 1997-2006).
Tinet et al., J. Opt. Soc. Am. A 13, 1903-1915 (1996).
Tsenova & Stoykova, “Refractive index measurement in human tissue samples,” in Proc. SPIE 5226, 413-417 (2003).
U.S. Patent Application Publication Nos. 2006/0247532; 2007/0232932.
van Veen et al., J. Biomed. Opt. 10, 54004 (2005).
Verkruysse et al., Phys. Med. Biol. 50, 57-70 (2005).
Wang et al., Comput. Methods Programs Biomed. 47, 131-146 (1995).
Wyman et al., J. Comput. Phys. 81, 137-150 (1989).
X-5 Monte Carlo Team, “MCNP Vol. I: Overview and Theory,” (available online from the Diagnostics Applications Group website, Los Alamos National Laboratory, 2003), pp. 130-158.
Zonios et al., Appl. Opt. 38, 6628-6637 (1999).

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A method for fast Monte Carlo simulation of diffuse reflectance of a multi-layered turbid medium to determine scaled diffuse reflectance for the multi-layered turbid medium and for using the scaled diffuse reflectance to determine optical properties of a multi-layered turbid medium with unknown optical properties, the method comprising:
performing a baseline Monte Carlo simulation of diffuse reflectance of a homogeneous turbid medium to determine a baseline set of simulated photon trajectories and exit weights for the homogeneous turbid medium;
scaling, based on relative optical properties of each layer in an n-layered turbid medium with selected optical properties to the optical properties of the homogenous turbid medium, the simulated photon trajectories and weights determined for the homogeneous turbid medium to determine a set of calculated photon trajectories and exit weights for the n-layered turbid medium and, from the set of calculated photon trajectories and exit weights, an impulse response representing photon exit weights and exit positions for the n-layered turbid medium;
convolving the impulse response with a beam profile for a source-detector geometry to determine a scaled diffuse reflectance for the n-layered turbid medium that would be detected by the source-detector geometry; and
using the scaled diffuse reflectance for the n-layered turbid medium with selected optical properties as a predicted diffuse reflectance input to an inverse model to determine optical properties of an n-layered turbid medium with unknown optical properties based on measured diffuse reflectance of the n-layered turbid medium with unknown optical properties.

2. The method of claim 1, wherein performing a baseline Monte Carlo simulation includes performing a single Monte Carlo simulation with a predetermined known set of optical properties.

3. The method of claim 2, wherein the predetermined known set of optical properties includes an absorption coefficient, a scattering coefficient, and an anisotropy factor.

4. The method of claim 2, wherein the predetermined known set of optical properties includes a numerical aperture of a simulated illumination fiber and a simulated collection fiber.

5. The method of claim 1, wherein performing a baseline Monte Carlo simulation includes dividing the homogeneous turbid medium into depth intervals of constant thickness or increasing thickness and measuring photon exit weights, number of collisions, and spatial offsets from incident photon positions in each depth interval.

6. The method of claim 1, wherein scaling the simulated photon trajectories based on the relative optical properties includes calculating thickness for a pseudo layer for each layer in the n-layered turbid medium with selected optical properties, the pseudo layer thickness for each pseudo layer being based on the optical properties of that layer relative to the optical properties of the homogeneous turbid medium and the pseudo layer having the optical properties of the homogeneous turbid medium, and determining a photon trajectory for each photon in each layer in the n-layered medium with selected optical properties based on the photon trajectory in the corresponding pseudo layer.

7. The method of claim 6, wherein scaling the simulated photon trajectories based on the relative optical properties includes determining a number of photon trajectories and a horizontal offset that each photon experiences in each pseudo layer before exiting the n-layered turbid medium with selected optical properties based on trajectory information from the baseline Monte Carlo simulation.

8. The method of claim 6, wherein scaling the photon trajectories based on the relative optical properties includes scaling a horizontal offset for each real layer in the n-layered turbid medium with selected optical properties according to a transport coefficient of each real layer and determining a vector sum of the horizontal offsets determined for all layers in the n-layered turbid medium with selected optical properties to determine a scaled exit distance for each photon exiting the n-layered turbid medium with selected optical properties.

9. The method of claim 6, wherein scaling the photon weights includes calculating a photon weight change in each pseudo layer according to an albedo of each real layer in the n-layered turbid medium with selected optical properties and a number of collisions in each pseudo layer and computing a product of all of the weight change terms to determine a scaled exit weight for each photon exiting the n-layered turbid medium with selected optical properties.

10. The method of claim 1, wherein using the scaled diffuse reflectance as a predicted reflectance input to determine optical properties of the n-layered turbid medium with unknown optical properties includes:
measuring diffuse reflectance of the turbid medium with unknown optical properties using an optical probe;
applying the inverse model using the scaled diffuse reflectance and the measured diffuse reflectance as inputs and producing an indicator of the difference between the scaled diffuse and measured diffuse reflectances as output;
iteratively repeating the inverse model by altering the scaled diffuse reflectance input until the indicator of the difference reaches a minimum value; and
outputting, as optical properties of the turbid medium having unknown optical properties, optical property values corresponding to the scaled diffuse reflectance that corresponded to the minimum value of the indicator.

11. The method of claim 10, wherein the indicator of the difference comprises a sum of squares of errors between the scaled and measured diffuse reflectances for different wavelengths.

12. The method of claim 11, wherein outputting the optical values includes outputting an absorption coefficient, a scattering coefficient, and an anisotropy factor.

13. A system for fast Monte Carlo simulation of diffuse reflectance of a multilayered turbid medium to determine a scaled diffuse reflectance for the multilayered turbid medium and for using the scaled diffuse reflectance to determine optical properties of a turbid medium having unknown optical properties, the system comprising:
a baseline Monte Carlo simulation module for performing a baseline Monte Carlo simulation of diffuse reflectance of a homogeneous turbid medium to determine a baseline set of simulated photon trajectories and exit weights for the homogeneous turbid medium;
a scaling module for scaling, based on relative optical properties in each layer in an n-layered turbid medium with selected optical properties to the optical properties of the turbid medium, the simulated photon trajectories and weights determined for the homogeneous turbid medium to determine a set of calculated photon trajectories and exit weights for the n-layered turbid medium, and, from the set of calculated photon trajectories and exit weights, an impulse response representing photon exit weights and exit positions for the n-layered turbid medium, wherein the scaling module is adapted to scale the photon trajectories for each layer in the n-layered turbid medium plural times to create a database of scaled photon trajectories and exit weights for the n-layered turbid medium; and
an inverse model for receiving as inputs the scaled simulated diffuse reflectance value stored in the database and measured diffuse reflectance from a multilayered turbid medium with unknown optical properties and for outputting optical properties of the multilayered turbid medium.

14. The system of claim 13, wherein the baseline Monte Carlo simulation module is adapted to perform a single Monte Carlo simulation with a predetermined set of optical properties.

15. The system of claim 14, wherein the predetermined known set of optical properties includes an absorption coefficient, a scattering coefficient, and an anisotropy factor.

16. The system of claim 14, wherein the predetermined known set of optical properties includes a numerical aperture of a simulated illumination fiber and a simulated collection fiber.

17. The system of claim 13, wherein performing a baseline Monte Carlo simulation includes dividing the homogeneous turbid medium into depth intervals of increasing thickness and measuring photon exit weights, number of collisions, and spatial offsets from incident photon positions in each depth interval.

18. The system of claim 13, wherein scaling the simulated photon trajectories based on the relative optical properties includes calculating thickness for a pseudo layer for each layer in the n-layered turbid medium with selected optical properties, the pseudo layer thickness for each pseudo layer being based on the optical properties of that layer relative to the optical properties of the homogeneous turbid medium and the pseudo layer having the optical properties of the homogeneous turbid medium, and determining a photon trajectory for each photon in each layer in the n-layered medium with selected optical properties based on the photon trajectory in the corresponding pseudo layer.

19. The system of claim 18, wherein scaling the simulated photon trajectories based on the relative optical properties includes determining a number of photon trajectories and a horizontal offset that each photon experiences in each pseudo layer before exiting the n-layered turbid medium with selected optical properties based on trajectory information from the baseline Monte Carlo simulation.

20. The system of claim 18, wherein scaling the photon trajectories based on the relative optical properties includes scaling a horizontal offset for each real layer in the n-layered turbid medium with selected optical properties according to a transport coefficient of each real layer and determining a vector sum of the horizontal offsets determined for all layers in the n-layered turbid medium with selected optical properties to determine a scaled exit distance for each photon exiting the n-layered turbid medium with selected optical properties.

21. The system of claim 18, wherein scaling the photon weights includes calculating a photon weight change in each pseudo layer according to an albedo of each real layer in the n-layered turbid medium with selected optical properties and a number of collisions in each pseudo layer and computing a product of all of the weight change terms to determine a scaled exit weight for each photon exiting the n-layered turbid medium with selected optical properties.

22. The system of claim 13, wherein using the scaled diffuse reflectance as a predicted reflectance input to determine optical properties of the n-layered turbid medium with unknown optical properties includes:
measuring diffuse reflectance of the turbid medium with unknown optical properties using an optical probe;
applying the inverse model using the scaled diffuse reflectance and the measured diffuse reflectance as inputs and producing an indicator of the difference between the scaled diffuse and measured diffuse reflectances as output;
iteratively repeating the inverse model by altering the scaled diffuse reflectance input until the indicator of the difference reaches a minimum value; and
outputting, as optical properties of the turbid medium having unknown optical properties, optical property values corresponding to the scaled diffuse reflectance that corresponded to the minimum value of the indicator.

23. The system of claim 22, wherein the indicator of the difference comprises a sum of squares of errors between the scaled and measured diffuse reflectances for different wavelengths.

24. The system of claim 23, wherein outputting the optical values includes outputting an absorption coefficient, a scattering coefficient, and an anisotropy factor.
